(19) United States
(12) Patent Application Publication
(10) Pub. No.: US 2025/0041780 A1
(43) Pub. Date: Feb. 6, 2025

(54) DIAMOND-PLEATED FILTER MEDIA

(71) Applicant: 3M INNOVATIVE PROPERTIES COMPANY, St. Paul, MN (US)

(72) Inventors: Emily K. Maher, Hugo, MN (US); Mark A. Sanocki, Vadnais Heights, MN (US); Andrew R. Fox, Oakdale, MN (US)

(21) Appl. No.: 18/780,963

(22) Filed: Jul. 23, 2024

Related U.S. Application Data
(60) Provisional application No. 63/530,463, filed on Aug. 2, 2023.

(51) Int. Cl. B01D 46/52; B01D 46/00

(52) U.S. Cl. CPC B01D 46/522; B01D 46/0001

(57) ABSTRACT

A pleated filter media comprising front pleats and rear pleats, with at least some of the front pleats having junctions at which local areas of adjoining front pleat walls of the front pleat are frontally joined together. The junctions may be at discrete locations that are spaced along a pleat direction of the front pleats. For any two nearest-neighbor front pleats, the junctions of one of the front pleats may be offset, along the pleat direction, from the junctions of the other front pleat.

### CROSS REFERENCE TO RELATED APPLICATIONS

This application claims priority from U.S. Provisional Application Ser. No. 63/530,463, filed 2 Aug. 2023, the disclosure of which is incorporated by reference in its/their entirety herein.

### BACKGROUND

Pleated filters are commonly used in filtration applications, e. g. in heating-ventilating-air conditioning (HVAC) systems, room air purifiers, and so on.

### SUMMARY

Herein is disclosed diamond-pleated filter media comprising front pleats and rear pleats. At least some of the front pleats comprise junctions at which local areas of adjoining front pleat walls of the front pleat are frontally joined together. The junctions may be at discrete locations that are spaced along a pleat direction of the front pleats. For any two nearest-neighbor front pleats, the junctions of one of the front pleats may be offset, along the pleat direction, from the junctions of the other front pleat. These and other aspects of the invention will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a front perspective view of an exemplary pleated filter media.

FIG. 2 is a side view, looking along the pleat direction, of an exemplary pleated filter media.

FIG. 3 is a side view, looking along the pleat direction, of another exemplary pleated filter media.

FIG. 4 is a side perspective view of another pleated filter media in a compacted configuration.

FIG. 5 is a plan view of the front side of an exemplary diamond-pleated filter media.

FIG. 6 is a perspective view of the front side of the exemplary diamond-pleated filter media of FIG. 5.

FIG. 7 is a magnified plan view of the front side of the exemplary diamond-pleated filter media of FIG. 5.

FIG. 8 is a front perspective view of an exemplary pleated filter media having local areas that can be joined together to form a diamond-pleated filter media.

FIG. 9 is a cross-sectional slice side view, looking along the pleat direction, of an exemplary diamond-pleated filter media.

FIG. 10 is a photograph of the front side of a Working Example diamond-pleated filter media.

FIG. 11 is a photograph of the rear side of a Working Example diamond-pleated filter media.

FIG. 12 is a perspective exploded view of a reusable frame for an air filter.

FIGS. 13a and 13b are plan views of the front sides of exemplary diamond-pleated filter media.

Like reference symbols in the various figures indicate like elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

Although terms such as “top”, bottom”, “upper”, lower”, “under”, “over”, ““up” and “down”, and “first” and “second” may be used in this disclosure, it should be understood that those terms are used in their relative sense only unless otherwise noted. As used herein as a modifier to a property, attribute or relationship, the term “generally”, unless otherwise specifically defined, means that the property, attribute or relationship would be readily recognizable by a person of ordinary skill but without requiring absolute precision or a perfect match (e.g., within +/−20% for quantifiable properties): the term “substantially” means to a high degree of approximation (e.g., within +/−10% for quantifiable properties) but again without requiring absolute precision or a perfect match. The term “essentially” means to a very high degree of approximation (e.g., within plus or minus 2% for quantifiable properties; it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match.

The term “front” and similar terminology denotes the side of a diamond-pleated filter media that comprises junctions resulting from joining local areas of adjoining front pleat walls as discussed in detail herein. The term “rear” and similar terminology denotes the other, opposing side of the diamond-pleated filter media. Various Figures include numerical identifiers and/or “f” and “r” arrows to aid in recognition of front and rear sides and directions.

### DETAILED DESCRIPTION

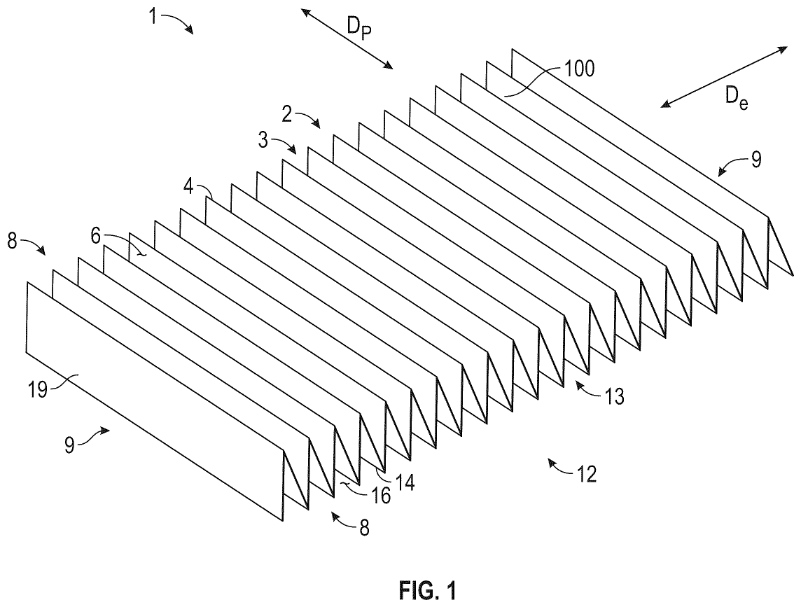

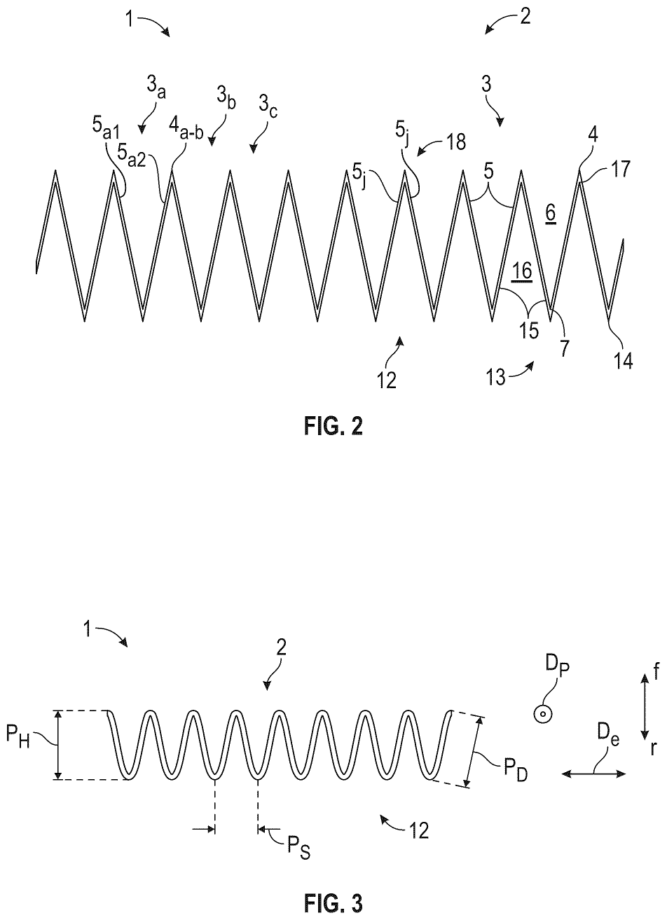

Disclosed herein is a diamond-pleated filter media. As a prelude to the characterization of diamond-pleated media, pleated media will be discussed in general, so that the particular characteristics of diamond-pleated media can be appreciated. Shown in perspective view from the front side in FIG. 1, and in side views in FIGS. 2 and 3, are pleated filter media 1 that comprise rows of generally oppositely-facing pleats. For precision of description, terminology herein will be couched in terms of front and rear sides and components of the pleated media. Pleated media 1 as presented in FIGS. 1 and 2 thus comprises a front side 2 and a rear side 12. When viewed from front side 2, pleated media 1 comprises front pleat walls 5 that define front pleats 3 that exhibit front pleat tips 4 and front pleat valleys 6. Similarly, when viewed from rear side 12, pleated media 1 comprises rear pleat walls 15 that define rear pleats 13 that exhibit rear pleat tips 14 and rear pleat valleys 16. The pleat walls are connected at front and rear pleat tips to form a pleated structure as evident in FIGS. 1 and 2.

According to the terminology herein, some pairs of front pleat walls 5 are adjoining pleat walls. By adjoining front pleat walls is meant two front pleat walls 5 that collectively define a front pleat valley 6 and face each other across this front pleat valley 6, and that are connected to each other at a front pleat valley floor 7 (which will be the opposite/front side of a rear pleat tip 14). By way of a specific example, the particular front pleat labeled 3ₐ in FIG. 2, comprises front pleat walls 5ₐ₁ and 5ₐ₂ that are adjoining. (Similar considerations hold for adjoining rear pleat walls 15 that face each other across a rear pleat valley 16 and that are connected to each other at a rear pleat valley floor 17.)

According to the terminology herein, some pairs of front pleat walls 5 are adjacent pleat walls. By this is meant two front pleat walls that are connected to each other at a shared front pleat tip 4 and that collectively provide a frontally-protruding “ridge” when the pleated media is viewed from the front. The two front pleat walls labeled 5ⱼ in FIG. 2 are adjacent front pleat walls that collectively provide a front ridge 18. Such adjacent front pleat walls will be distinguished from the above-defined adjoining front pleat walls.

According to the terminology herein, some pairs of front pleats 3 are nearest-neighbor pleats. By this is meant that the two front pleats share a common front pleat tip 4. By way of specific examples, the particular front pleats 3ₐ and 3_{b} as shown in FIG. 2 are nearest-neighbor front pleats (sharing a common front pleat tip 4_{a-b}). Front pleats 3_{b} and 3_{c} are likewise nearest-neighbor pleats; however, front pleats 3ₐ and 3ₑ are not nearest-neighbor pleats.

In many embodiments, a pleated media 1 will be generally rectangular in overall shape (which includes square shapes) and will exhibit two opposing corrugated edges 8 that exhibit a generally undulating (typically, zig-zag) shape when viewed along the pleat direction (as in FIGS. 2 and 3) and two opposing non-corrugated ends 9, as indicated in FIG. 1. In many embodiments, a pleated media will exhibit a pleat direction D_{P} as indicated on FIG. 1; such a direction is aligned with the long axis of the pleat tips 4 as evident from FIG. 1. The pleated media will also exhibit an “expansion” direction Dₑ (as discussed below in detail) that is generally orthogonal to the pleat direction D_{P}, as indicated in FIG. 1.

The pleat direction D_{P} and expansion direction Dₑ and other geometric properties of pleated media are illustrated in FIG. 3. The front-rear direction (indicated by arrow f-r in FIG. 3) is a direction extending through the pleated media from the front side 2 to the rear side 12, and typically corresponds to the overall direction of fluid flow (e.g. airflow) through the filter media. Other geometric parameters of pleated media 1 are indicated in FIG. 3. All such parameters will be evaluated with the pleated media in an expanded, end-use configuration as discussed below, unless otherwise noted. The pleat height (pleat amplitude) is the distance (PH in FIG. 3) from a front pleat tip 4 to a rear pleat tip 14, along a direction that is orthogonal to the overall major plane of the pleated filter media (i.e., along a direction that is aligned with the front-rear direction of the pleated media). In various embodiments, the pleat height of a pleated media may be at least 2, 4, 6, 8, 10, 12, or 16 mm. In further embodiments, the pleat height may be at most 150, 100, 45, 40, 35, 30, 25, 20, 15, 12, 10, 8, or 6 mm.

The pleat spacing (P_{S} in FIG. 3) is the distance between nearest-neighbor same-side pleat tips, along a direction that is aligned with the overall major plane of the pleated filter media (i.e., along the expansion direction Dₑ of the pleated media). A pleated filter media 1 may comprise any suitable pleat spacing. In various embodiments the pleat spacing may be at most 40, 30, 20, 15, 10, 8, 6, or 4 mm; in further embodiments the pleat spacing may be at least 2, 3, 4, 5, 6, 8, or 10 mm. (If desired, the pleat spacing may be characterized in terms of the pleat frequency, e.g. in pleats per inch or pleats per cm; pleat spacing is easily convertible into pleat frequency and vice versa.)

The pleat distance (P_{D} in FIG. 3) is the shortest distance from one pleat tip to a nearest-neighbor pleat tip along a pleat wall that connects the two (by way of specific example, if a first pleat tip is a front pleat tip 4 its nearest-neighbor pleat tip for purposes of this measurement will be a rear pleat tip 14). For a pleated filter media 1, the pleat distance P_{D} may often be close to, or somewhat larger than, the pleat height PH (noting that as the pleated media is expanded as described later herein, the pleat distance will remain the same but the pleat height will decrease). Pleated filter media 1 may comprise any suitable pleat distance. In various embodiments, the pleat distance of the pleated media can be at least 2, 4, 6, 8, 10 or 16 mm. In further embodiments, the pleat distance may be at most 150, 100, 45, 40, 35, 30, 25, 20, 15, 12, 10, 8, or 6 mm.

Although not denoted specifically in FIGS. 2-3, a pleated filter media 1 may comprise pleat tips with any suitable radius of curvature (as evaluated in the general manner disclosed in U.S. Pat. No. 11,253,807). In some embodiments the pleat tips of pleated media 1 may have an average radius of curvature that is less than 5 mm. In various embodiments, such pleats may comprise tips with an average radius of curvature of at most 3.0, 2.5, 2.0, 1.5, 1.0, or 0.5 mm. In some embodiments the pleated media may be tightly pleated, meaning that the media has a relatively small pleat spacing and that the pleat tips exhibit a small radius of curvature in comparison to the pleat height. In various embodiments, the pleated media may exhibit a pleat tip radius of curvature that is less than 2.0, 1.0, or 0.5 mm, in combination with a pleat spacing that is less than 8, 6 or 4 mm and with a pleat height that is from at least 6, 8 or 12 mm to at most 40, 30 or 25 mm. Tightly-pleated pleats with such a small radius of curvature may often be relatively sharp-tipped, “zig-zag” style pleats that are distinguished from e.g. sinusoidal pleats that exhibit pleat “tips” with a large radius of curvature. Such zig-zag style pleats may also often exhibit relatively flat pleat walls (that meet at pleat tips with a very small radius of curvature), again in contrast to sinusoidal pleats. Such pleats may be advantageously used in relatively stiff filter media and may be obtained e.g. by scoring the filter media to provide fold lines along which the media is then folded to form sharp pleat tips.

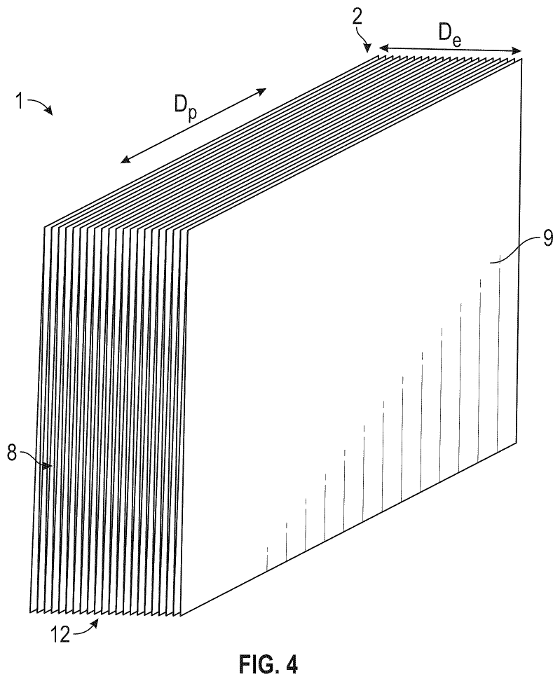

In many embodiments, providing a filter media 1 in a pleated configuration of the general type described herein can allow the filter media to be collapsed, accordion-style, into a compacted configuration in which the pleat walls are crowded quite close together or are even in at least partial contact with each other. A pleated filter media in such a compacted configuration is depicted in exemplary embodiment in FIG. 4. Such a pleated, compactable filter media can be stored, inventoried, shipped, displayed, etc., in this compacted condition and can then be expanded into an expanded, end-use configuration for use. Any such expansion will be along the above-described expansion direction Dₑ. (In the end-use configuration, the pleated filter media will typically have a span, along the expansion direction Dₑ, that matches the span of a support frame or filter receptacle into which the media is to be installed) for use.) In many embodiments, the pleated media 1 may be reversibly expandable and compactable along this expansion direction Dₑ. However, in some embodiments the pleated filter media may only need to be expandable from a compacted configuration to an expanded, end-use configuration a single time. That is, in some such embodiments, the pleated filter media, once expanded, may not need to be collapsible back to the original compacted configuration.

In some embodiments, a removable wrapper or other packaging can be provided to initially retain a pleated filter media in a compacted state, and can be removed to allow expansion. Regardless of the specific manner in which it is packaged, an expandable pleated filter media as described herein media does not require a conventional factory-installed support frame that holds the filter media in a permanent, unchangeable shape. Rather, in many embodiments an expandable pleated filter media will not be provided with any kind of support frame permanently attached thereto. As noted, such a filter media can advantageously be shipped, inventoried, displayed, and so on, in the compacted state, and can be expanded for use, e.g. for installation into a reusable frame.

### Diamond-Pleated Filter Media

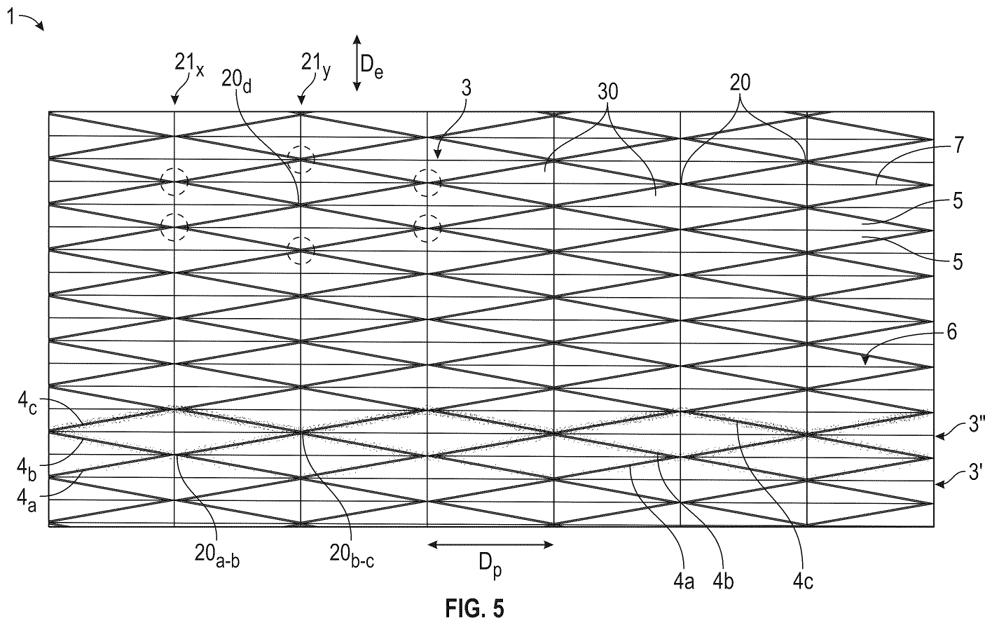

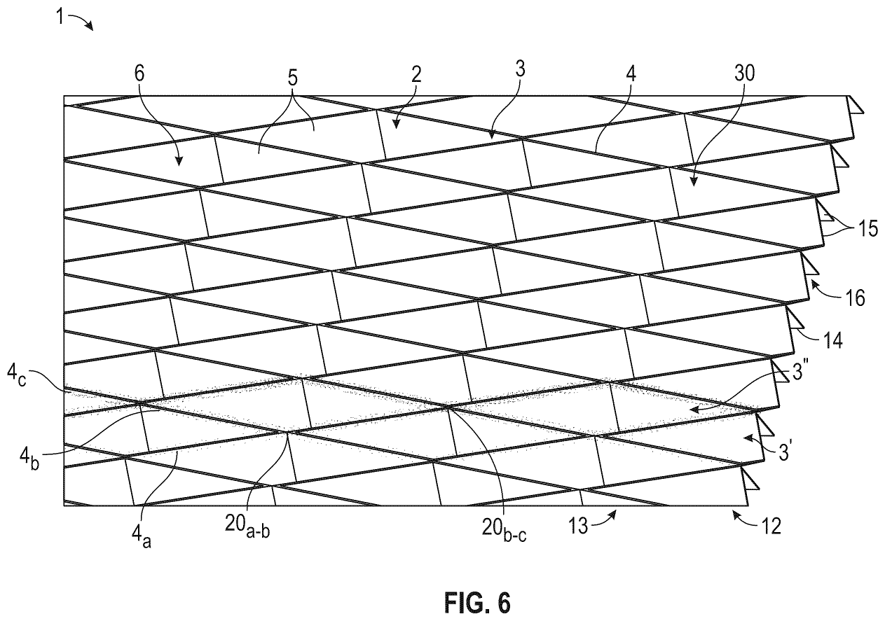

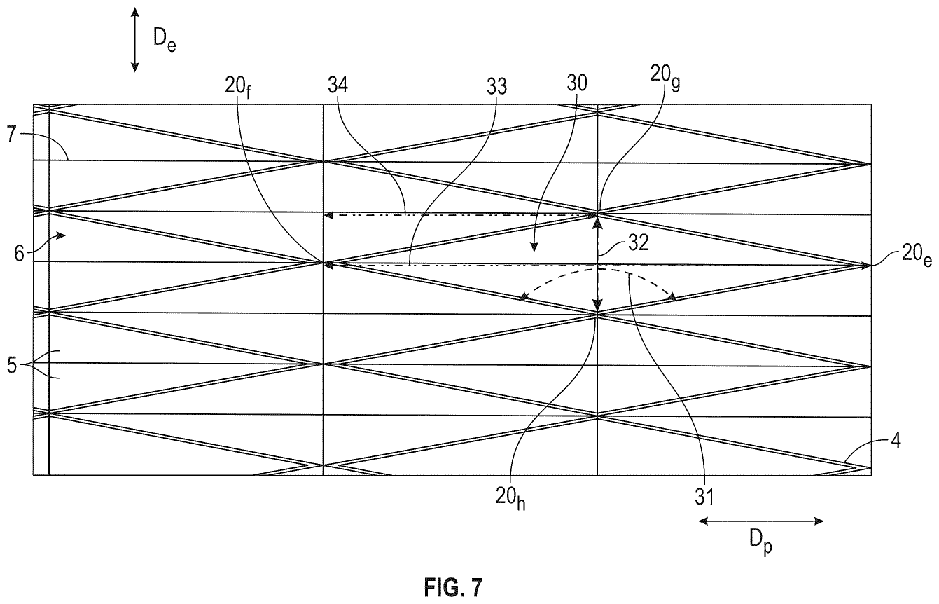

With the above as background, the particular pleat arrangements presented herein will be discussed. The herein-disclosed pleating arrangements make use of junctions that are provided between local areas of front pleat walls and that are arranged in a particular manner. The resulting pleating patterns will be referred to herein as providing “diamond-pleated” filter media. Representative diamond-pleated filter media 1 are depicted in FIGS. 5, 6 and 7. FIG. 5 is a front plan view of such media; FIG. 6 is a perspective view, from the front, of such media, and FIG. 7 is again a front plan view, magnified so that additional details can be depicted.

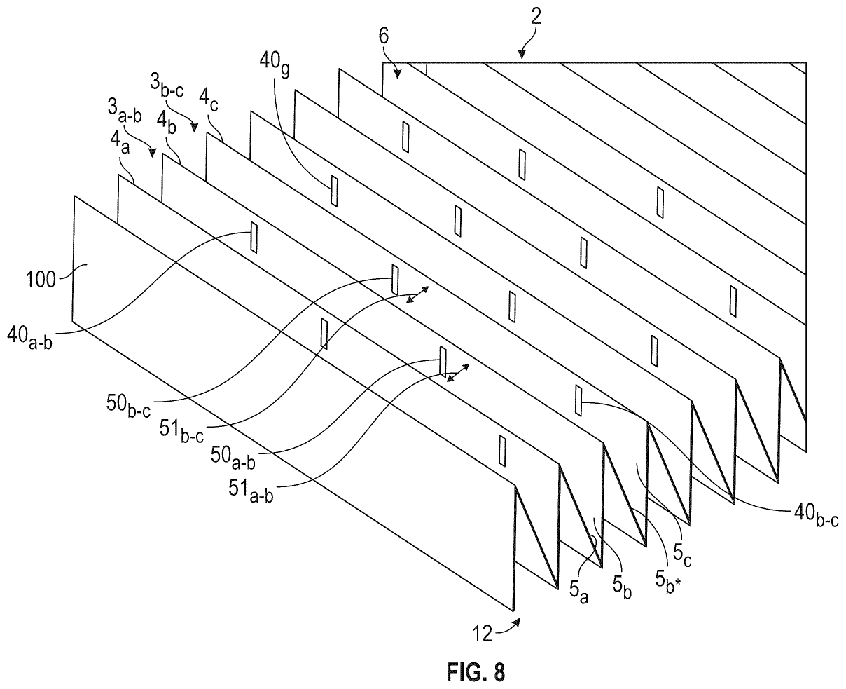

The generation of such a pleat arrangement can be described with reference to FIG. 8, which depicts a conventional pleated media (of the type depicted in FIGS. 1-3) before having been formed into a diamond-pleated arrangement. In FIG. 8, local areas of front pleat walls 5 that will be frontally joined to form junctions 20, are indicated as areas 50. In some embodiments, such local areas can be joined by disposing parcels 40 of adhesive (e.g., hot-melt adhesive, as discussed in detail later herein) on local areas 50 of front pleat walls 5. (In FIG. 8, various areas/parcels have been labeled 40 or 50; it will be understood that in the depicted embodiment these areas/parcels are coincident). In some embodiments, the deposition of adhesive parcels 40 onto local areas 50 may be done with the pleated media in an at least semi-expanded condition as in FIG. 8 (in some embodiments, the media may be expanded nearly flat while the adhesive is deposited). With the adhesive parcels 40 in place on local areas 50, the media can then be compacted so that each parcel of adhesive 40 (which is already in contact with the local area 50 of the front pleat wall 5 upon which it was deposited) comes in contact with the complementary local area 50 of the adjoining front pleat wall 5. The adhesive can then be hardened so that a bond is established between the two local areas 50, thus frontally joining them together to form a junction 20 between the two adjoining front pleat walls 5.

By way of a specific example, the front pleat labeled 3_{a-b} in FIG. 8 comprises adjoining front pleat walls 53 and 5_{b} with pleat wall 5_{b} having local areas 50_{a-b} upon which have been deposited parcels of adhesive 40_{a-b}. (The complementary local areas 50 of front pleat wall 5ₐ are not visible from the viewing angle of FIG. 8.) The front pleat walls 5ₐ and 5_{b} are brought together as indicated by arrow 51_{a-b} so that the parcels of adhesive 40 establish frontal bonds between the local areas 50 of pleat walls 5ₐ and 5_{b}. Similarly, the front pleat labeled 3_{b-c} (which is a nearest-neighbor front pleat to front pleat 3_{a-b}) comprises adjoining front pleat walls 5_{b*} and 5_{c}, with pleat wall 5_{c} having areas 50_{b-c} upon which have been deposited parcels of adhesive 40_{b-c}. The pleat walls 5_{b*} and 5_{c} are brought together (as indicated by arrow 51_{b-c}) so that the parcels of adhesive establish a frontal bond between the local areas of the pleat walls.

Many variations on the above general procedures are possible. In some embodiments, a junction may be formed by depositing adhesive on a local area of one front pleat wall, with the deposited adhesive being brought into contact with the complementary local area of the adjoining front pleat wall when the front pleat walls are brought together. Or, such a junction may be formed by depositing adhesive on the local areas of both of the front pleat walls, with the parcels of adhesive coming into contact with each other (and merging to become a single layer of adhesive) when the front pleat walls are brought together.

Any such procedures, regardless of the particular manner in which they are performed, will result in local areas 50 of the adjoining front pleat walls 5 of each front pleat 3 being frontally joined to each other. By frontally joined and like terminology is meant that the local areas 50 of two adjoining front pleat walls are positioned (e.g., are brought together as indicated by arrows 51_{a-b} and 51_{b-c}) so that the front surfaces of the local areas 50 are held in close abutment to each other (close abutment being defined as being separated by 2.0 mm or less). Such frontal joining will have the result that any front pleat valley 6 that was present before the frontal joining, will be at least substantially collapsed between frontally-joined local areas 50 of the front pleat walls 5 so that front pleat valley 6 locally substantially disappears between the local areas 50. This can be seen in FIG. 8 (discussed later in detail), which is a side view that reveals how such joining causes front pleat valleys 6 to locally collapse.

### Offset Junctions

As evident from FIG. 8, for each front pleat 3, the local areas 50 upon which parcels of adhesive 40 are disposed are spaced apart from each other along the pleat direction. That is, the local areas that are to be joined together, are discrete areas that are spaced along the pleat direction rather than extending continuously along the pleat direction. Moreover, for each pair of nearest-neighbor front pleats the local areas 50 of one front pleat are offset, along the pleat direction, from the local areas 50 of the other front pleat.

This is illustrated in FIG. 8 for nearest-neighbor front pleats 3_{a-b} and 3_{b-c}. As evident in FIG. 8, the local areas and bonds 50_{a-b}/40_{a-b} of front pleat 3_{a-b} are offset, along the pleat direction, from the local areas and bonds 50_{b-c}/40_{b-c} of front pleat 3_{b-c}. In other words, for any two nearest-neighbor front pleats, the local, joining areas of the two front pleats are staggered, along the pleat direction, relative to each other, as is evident from FIG. 8.

The above-described procedure will result in the formation of junctions 20 between adjoining front pleat walls 5 of front pleats 3. Typically, the bonding of these local areas 50 to form junctions 20 will be completed (e.g. a bonding adhesive 40 will be hardened) with the pleated media in a compacted configuration in which the front pleat walls 5 (and the rear pleat walls 15) are abutted closely together. Thus, at the resulting junctions 20, the local areas 50 of the adjoining front pleat walls 5 are held in close abutment to each other (e.g., less than or equal to 2.0, 1.5, 1.0, 0.7, 0.5, 0.2, or 0.1 mm) and are bonded to each other so as to be permanently held in this closely-abutting arrangement. However, for any front pleat 3, the spaces that are interspersed between junctions 20 (along the pleat direction) do not have any such bonds/junctions between the front pleat walls, so in these spaces the front pleat walls are not restricted from expanding apart from each other. This being the case, taking a pleated media that comprises junctions 20 as described above and expanding the pleated media (along the expansion direction) from a compacted configuration, will cause the front pleats to expand in locations between the junctions, but no such expansion will occur at the junctions themselves. The expansion can be continued until the junctions limit any further expansion, even in locations between the junctions. The providing of the junctions in an offset pattern as described above will ensure that such expansion will cause the pleated media (specifically, the front pleat tips 4 and/or front pleat ridges 18) to exhibit a generally diamond-shaped pattern when viewed from the front side, as shown in FIGS. 5-7. (For precision of description, a conventional pleated media of the general type depicted in FIG. 8, which in at least some embodiments may serve as a precursor (input media) to a diamond-pleated media, will be referred to as a linearly-pleated media, to distinguish this from a diamond-pleated media.)

From FIGS. 5-7 it can be appreciated that in a diamond-pleated media, the front pleat tips 4 (and, the previously-mentioned front ridges 18 that bear the front pleat tips 14) no longer extend along the pleat direction of the media in a geometric arrangement in which all the front pleat tips (and front ridges) are linear, uniaxial, and parallel to each other across the entire breadth of the pleated media from one corrugated edge to the other. Rather, in a diamond-pleated pattern, each front pleat tip 4 and associated ridge will deviate systematically from such a purely linear, uniaxial path. This is illustrated in FIG. 5 with reference to two particular nearest-neighbor front pleats (labeled 3′ and 3″ in FIG. 5) and associated front pleat tips 4ₐ, 4_{b} and 4_{c}. (In FIG. 5, these pleat tips are outlined in semi-transparent stippling that is superimposed on them, with pleat tips 4ₐ, 4_{b} and 4_{c} being respectively at low, medium and high stippling dot density). Pleat tip 4_{b} is the common front pleat tip shared by nearest-neighbor pleats 3′ and 3″: 4ₐ and 4_{c} are the pleat tips that bracket pleat tip 4_{b} in the expansion direction.

Taking front pleat tip 4_{b} as a representative example, this pleat tip does not extend strictly linearly and uniaxially along the pleat direction D_{P} but rather proceeds in a zig-zag manner in which pleat tip 4_{b} has successive, alternating junctions with its nearest-neighbor pleat tips 4ₐ and 4_{c}. (Representative junctions 20_{a-b} and 20_{b-c} are indicated in FIG. 5; junction 20_{a-b} is a junction between pleat tip 4ₐ and pleat tip 4_{b}; junction 20_{b-c} is a junction between pleat tip 4_{b} and pleat tip 4_{c}.) That is, each individual front pleat tip 4 (e.g., pleat tip 4_{b}) is in the form of a series of line segments that are end-to-end connected at junctions 20 and that form an overall shape that is a regular skew apeirogon (colloquially, a zig-zag).

The above discussions make it apparent that in a diamond-pleated media, the local “pleat direction” is not strictly constant along the length of any one front pleat tip. Rather (particularly when the media is fully expanded), each individual line segment of the front pleat tip will be at a slight off-angle from the overall pleat direction, e.g. as evident for representative front pleat tip 4_{b}. For simplicity of description, the overall direction of the pleat tips will still be referred herein to as the pleat direction (D_{P}, as indicated in FIG. 5), it being understood that the off-angles of the individual line segments will cancel each other out so that the pleat tip, as a whole, collectively exhibits the overall pleat direction D_{P}. Since these off-angles (that is, the local deviations from the overall pleat direction) are typically rather small (e.g., a few degrees), each such line segment will still be considered as being generally aligned with the overall pleat direction D_{P}.

### Pockets

As can be seen from the perspective view of FIG. 6 (in which nearest-neighbor front pleats 3′ and 3″ and associated pleat tips 4ₐ, 4_{b} and 4_{c} are indicated), the above-discussed arrangements result in the formation of three-dimensional pockets 30 that, when viewed from the front side of the media, are generally rhombus (diamond) shaped. These pockets 30 are frontwardly-open-ended and are closed on their rear ends (at front valley floors 7). Various parameters of the pockets 30 of a diamond-pleated filter media are indicated in the magnified plan view of FIG. 7. All such parameters will be evaluated with the diamond-pleated media in an expanded, end-use condition unless otherwise indicated.

Each pocket 30 will have a long axis that is aligned with the pleat direction and will exhibit a pocket length 33 along this direction. Each pocket 30 will also have a short axis that is aligned with the expansion direction and will exhibit a pocket width along this direction. The width of the pocket will vary along the length of the pocket and will be at a minimum (e.g., less than or equal to 2.0, 1.5, 1.0, 0.7, 0.5, 0.2, or 0.1 mm) at the junctions 20 that define the terminal ends of the pocket along the pleat direction. The width of the pocket will typically be at a maximum at a location halfway (along the pleat direction) between these terminal end junctions 20. References herein to the width of a pocket will be understood to be measured at the location where the width is largest; typically this will be midway along the length of the pocket, as for width 32 as indicated in FIG. 7. References herein to a maximum pleat spacing of the diamond-pleated media refer to the pleat spacing at its widest; this maximum pleat spacing will typically correspond to the width 32 of the pockets.

A representative pocket 30 is indicated in FIG. 7, and is terminated along the pleat direction by junctions 20ₑ and 20_{f}; the distance between these junctions, along the pleat direction, is the length 33 of the pocket along its long axis as noted above. Each pocket will also have a half-length 34 which will correspond to the offset distance at which a set of junctions (e.g. the set including 20_{g} and 20ₕ) is offset, along the pleat direction, from a neighboring set of junctions (e.g. the set including 20_{f}). Pocket 30 is additionally bounded by junctions 20_{g} and 20ₕ with the distance between these junctions, along the short axis of the pocket (i.e., in the expansion direction), being the width 32 of the pocket. It will be appreciated that the width of the pockets can vary considerably depending on the degree to which the diamond-pleated media is expanded. In some instances the media may be expanded to its maximum possible extent, such that the junctions 20 prevent any further expansion. Or, in some instances, the media may only be expanded to some fraction of this maximum possible extent, as discussed in detail later herein. Typically, all of the pockets will exhibit very similar expansion, and the geometric properties of all the pockets will often be quite similar over the entire area of the diamond-pleated media, excepting e.g. any edge effects as discussed later herein and excepting a circumstance in which the sizes and/or shapes of the pockets are purposefully varied in different regions of the diamond-pleated media.

The overall dimension of a diamond-pleated media along its expansion direction (i.e. from one non-corrugated end of the media, to the other, opposing non-corrugated end), which will be termed herein as the “span” of the media, will vary commensurately with any expansion of the “width” of the individual pockets. A diamond-pleated media can be dimensionally-adjustable in the sense that it can be expanded to any desired amount along its expansion direction, up to its maximum possible span as limited by the junctions. This provides that the span of the media from one non-corrugated end to the other along the expansion direction can be chosen to fit a receptacle of a particular dimension.

Conversely, in some embodiments the length of the individual pockets and the breadth of the diamond-pleated media from one corrugated edge to the other (both of which are along the pleat direction) may not vary significantly with expansion of the media along the expansion direction. In some embodiments the length of the individual pockets and the overall breadth of the diamond-pleated media may not vary significantly when force is applied along the pleat direction. In other words, in some embodiments a diamond-pleated filter media may be quite expandable along the expansion direction (e.g. up to an expansion ratio of 2, 3 or 4 as discussed later herein) while being generally or substantially non-expandable along the pleat direction (e.g., expandable less than 20, 10 or 5% when gentle manual force is applied along the pleat direction). However, this is not necessarily the case; in some embodiments at least a small amount of expansion may be possible along the pleat direction. In some embodiments, significant expansion may be possible along the pleat direction, e.g. so that the diamond-pleated media is significantly expandable along two orthogonal directions.

Junctions 20 may be arranged so that pockets 30 exhibit a length to width ratio of at least 4:1, 6:1, or 8:1. In further embodiments, such a ratio may be at most 20:1, 16:1, 12:1, or 10:1. Again, this ratio will be affected not only by the chosen arrangement of the junctions, but also by the amount to which the media is expanded along the expansion direction. This ratio may grow very large when the media is in its compacted condition. Thus, ratios as presented herein will be understood as being evaluated when the diamond-pleated media is in a chosen expanded, end-use configuration. In some embodiments, the junctions may be arranged so that the pockets (excepting any edge effects as discussed later herein) are rather uniform in shape and size over the entire area of the diamond-pleated media, as in the exemplary design of FIG. 5.

Each junction 20 will represent a “node” at which two neighboring front pleat tips approach each other and then diverge, as with pleat tips 4ₐ and 4_{b} that meet at junction 20_{a-b} and then diverge, as visible in FIGS. 5 and 6. At each junction 20, each front pleat tip 4 will exhibit a vertex angle (whose vertex coincides with the junction), as with vertex angle 31 of junction 20ₕ as indicated in FIG. 7. Such an angle will generally be less than 180 degrees and greater than 90 degrees. In various embodiments, such a vertex angle may be less than 175, 170, or 165 degrees. In further embodiments, such a vertex angle may be more than 150, 155, or 160 degrees. By way of a specific example, the particular diamond-pleated arrangement shown in FIGS. 5-7, exhibits vertex angles in the range of approximately 165 degrees.

In many embodiments, these vertex angles may be rather uniform and consistent throughout the entire area of the diamond-pleated media, as in the exemplary design of FIG. 5. It will however be appreciated that the vertex angles will vary depending on the amount to which the diamond-pleated media is expanded. When the media is in its compacted configuration, the vertex angles may approach 180 degrees, with the vertex angles decreasing, and eventually reaching a minimum, as the media is expanded. Thus, vertex angles as disclosed herein will be understood as being evaluated when the diamond-pleated media is in a chosen expanded, end-use configuration.

In many embodiments, junctions 20, as offset as described herein, may form a hexagonal array. This is indicated for exemplary junction 20_{d} of FIG. 5, which has six nearest-neighbor junctions (all unnumbered, but circled in dashed lines) arranged in a hexagonal pattern. In many embodiments, the spacing of the junctions along the expansion direction may be less than the spacing of the junctions along the pleat direction, in order that pockets are formed that are elongated along the pleat direction and that are narrower (but are expandable) along the expansion direction, as evident from FIGS. 5-7.

The above-discussed diamond-pleating parameters (e.g., junction spacing, vertex angles, pocket length and width, etc.) may be chosen in combination with any of the previously-described pleating parameters (e.g. pleat spacing, pleat height, etc.), to provide a diamond-pleated filter media with desired properties. (All numerical examples that follow will be understood to be evaluated when the diamond-pleated filter media is in an expanded, end-use configuration). Thus for example, a diamond-pleated filter media may exhibit a pleat height of from 1.5 cm to 3.0 cm and a pleat density of from 0.3 to 3.0 pleats per cm. The junctions may be spaced along the pleat direction of each front pleat so that the resulting pockets have a length of from 2 to 7 cm. The above ranges (in particular, a pleat height in the range of e.g. 2.5 cm) may be suitable for an air filter of nominal 1-inch (2.5 cm) depth, which is a commonly-used, standardized air filter dimension. However, the herein-disclosed diamond-pleating arrangements may be used in any pleated filter media, including so-called deep-pleat filters that may have nominal depths (and thus pleat heights) of up to, e.g. 4, 5 or even 6 inches (e.g. approximately 10, 13, or 15 cm). In such cases, the various other parameters (e.g., pleat spacing, junction spacing, and so on) may be adjusted to optimum ranges for such media.

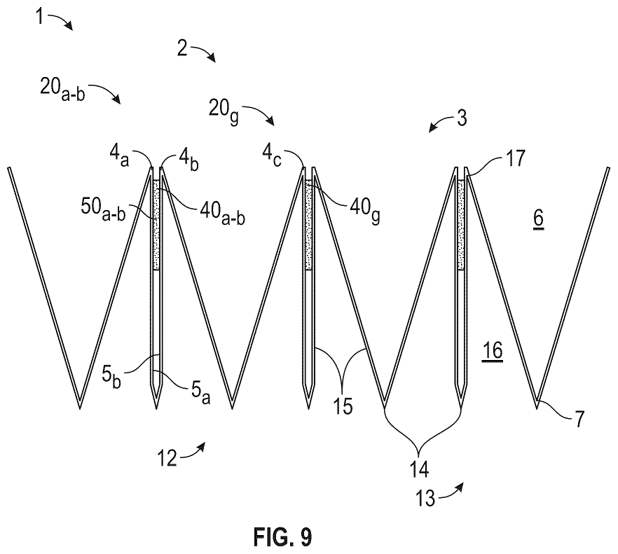

The above-described frontal joining of local areas 50 of front pleat walls 5 together to form junctions 20 may be further discussed with reference to FIG. 9, which is a cross-sectional slice view, looking along the pleat direction, of a set of junctions 20 and their associated local areas 50 and adhesive parcels 40 used to join local areas 50 together. (Such a set of junctions may be, e.g., the set labeled 21ₓ, or the set labeled 21_{y}, in FIG. 5.) FIG. 9 depicts, in idealized representation, the previously-described arrangement in which the joined local areas 50 of front pleat walls 5 are held in close abutment. Thus for junction 20_{a-b} of front pleat tips 4ₐ and 4_{b}, local areas 50_{a-b} of adjoining front pleat walls 5ₐ and 5_{b} are bonded to each other to form junction 20_{a-b}, by adhesive parcel 40_{a-b} which is present as a very thin layer. In various embodiments, such an adhesive layer may have a thickness of e.g. less than or equal to 2.0, 1.5, 1.0, 0.8, 0.6, 0.4, 0.3, 0.2, or 0.1 mm. Similarly, junction 20_{g} is formed by bonding via an adhesive parcel 40_{g}, again present as a very thin layer.

### Adhesive

The above-discussed arrangements share the premise that in forming a junction 20, an adhesive can be disposed so that the joined local areas 50 of the front pleat walls are maintained in close abutment (e.g., within about 0.5 mm). This can provide that at junctions 20, the local, joined areas of the front pleat walls are permanently held in close proximity to each other, even as, in locations spaced away (along the pleat direction) from the junctions, these same front pleat walls are able to be expanded far apart from each other along the expansion direction to form diamond-shaped pockets 30 as discussed elsewhere herein. In order to achieve this, in some embodiments the adhesive may be present as a very thin layer as noted above. For example, the adhesive bonding to form junctions may be performed by depositing the adhesive onto local areas 50 while the media is in a relatively expanded condition. The front pleat walls may then be brought together so that the as-deposited parcels of adhesive are compressed between the front pleat walls so as to end up much reduced in thickness (in comparison to its as-deposited thickness), thus achieving the desired thin layers of adhesive. Of course, in some embodiments an adhesive parcel may be deposited onto a local area of a pleat as a thin layer e.g. of the desired final thickness and that occupies the desired local area of the pleat wall. In such cases the adhesive may be brought into contact with the complementary local area of the adjoining pleat wall without any significant compression of the adhesive.

Use of adhesives in this manner can be contrasted with the conventional use of adhesives that are hardened in pleated media with the media in an end-use configuration in which the pleat walls are widely separated. In such conventional uses, the adhesives are applied in large amounts to serve as spacers that occupy pleat valleys to maintain the pleated media in its expanded, end-use configuration. Examples in of adhesives being used as spacers to maintain pleats in an expanded, end-use configuration, which are distinguished from the herein-presented arrangements, include the arrangements disclosed in U.S. Pat. Nos. 7,896,940 and 8,419,817.

The use of thin layers of adhesive in the manner disclosed herein may be characterized by way of a ratio of the thickness of the layer of adhesive to the maximum pleat spacing to which the pleated media is expandable in the end-use condition. (This maximum pleat spacing will correspond to the pocket width 32 as indicated in FIG. 7.) In various embodiments, this maximum pleat spacing/pocket width may be e.g. 0.2, 0.4, 0.8, 1.2, 1.6, or 2.0 cm. In various embodiments, the adhesive layer thickness may be less than or equal to 2.0, 1.5, 1.0, 0.8, 0.6, 0.4, 0.3, 0.2, or 0.1 mm as noted above. In various embodiments, the ratio of the thickness of the adhesive layer to the maximum pleat spacing of the diamond-pleated media may be from at least 1, 2, 4, or 6%, to at most 40, 20, 10, or 8%.

In some embodiments, the above-discussed arrangements may be configured so that the adhesive fills at least some, or much of, the front pleat valley 6, e.g. from the front pleat valley floor 7 to near (e.g., within 3, 2 or 1 mm of) the front pleat tip 4. The joined local areas 50 thus may extend along much of the extent of each front pleat wall 5, along the previously-described pleat distance. In some embodiments the extent of these joined local areas 50 along the pleat wall, in the direction of the pleat distance, may be purposefully limited. In particular, if an adhesive is used to perform the joining, care may be taken that the adhesive, in its final configuration in the thus-formed junction, stops short of the front pleat tip 4 (e.g., in the general manner shown in idealized representation in FIG. 9). By stops short is meant that the adhesive does not come within 1.0 mm of the peak of the pleat tip. This can ensure that no adhesive extends above a front pleat tip 4 in a manner that might undesirably cause the front pleat tip to be adhesively bonded to a non-nearest-neighbor front pleat tip.

In further detail, for the particular junction 20_{a-b} as depicted in FIG. 9, it would not be desirable for pleat tip 4ₐ of junction 20_{a-b} to be bonded to any pleat tip other than nearest-neighbor pleat tip 4_{b}. For example, it would not be desirable for pleat tip 4ₐ to be inadvertently bonded to pleat tip 4_{c}, which is not a nearest-neighbor pleat tip of pleat tip 4ₐ, as this would disrupt the diamond-pleating pattern. Ensuring that the bonded local areas 50 do not extend all the way up the front pleat walls to the front pleat tips 4 may beneficially ensure that no inadvertent bonding of non-nearest-neighbor front pleat tips occurs. To this end, an adhesive parcel 40 may be deposited in a particular amount, and/or in a particular region or subarea of a local area 50 that is to be bonded, in view of the fact that the adhesive parcel may spread (e.g. so as to occupy the entirety of a local area 50 that is desired to be bonded) when the adhesive is thinned by being compressed between the front pleat walls as described above. The amount and location of the adhesive may be chosen to ensure that any such adhesive spreading does not cause the adhesive to reach the front pleat tips. However, in other embodiments (e.g. in which junctions are formed by methods other than using deposited adhesives, as discussed later herein) the joined-together local areas of front pleat walls may extend up to, and e.g. include, the pleat tips themselves.

Thus in various embodiments, any local area 50 of a front pleat wall 5 that is joined to a complementary local area 50 of an adjoining front pleat wall 5 to form a junction 20, may occupy e.g. from 5, 10, 15, or 20%, up to e.g. 30, 50, 70, or 90%, of the pleat distance along the front pleat wall. In some embodiments, this local area will include a zone or subarea that is no further away from the front pleat tip 4 than 20% of the pleat distance. In other words, in some cases it may be preferable for at least some, most, or all of the bonded local area to be near the front pleat tip (rather than the bonded area being located primarily near, or extending all the way to, the front valley floor 7) while nevertheless not encompassing the front pleat tip 4 itself. Such arrangements are shown in idealized representation in FIG. 9.

As noted, in some embodiments junctions 20 can be generated by the use of adhesive. The term “adhesive” is used broadly to signify any material that can be deposited, e.g. as a parcel or bead, onto a pleat wall of a linearly-pleated precursor media in a state (e.g., liquid, molten, softened, or semi-softened) in which the adhesive is sufficiently flowable that it can be deformed to a desirably thin layer and then hardened so as to join local areas of front pleat walls together to form a junction. This may occur e.g. by way of the adhesive forming an adhesive bond to the surfaces of the fibers of the media and/or by way of the adhesive penetrating at least slightly into the interstices of the fibrous network and, after hardening, being mechanically enmeshed within the fibrous network.

Any suitable material may be used, including e.g. hot-melt adhesives, UV-cure adhesives, thermally-cured adhesives, moisture-cure adhesives, and so on. In some embodiments, the adhesive may be a hot-melt adhesive that is deposited through e.g. conventional hot-melt deposition methods (e.g. by use of a grid melter), after which the adhesive is cooled to harden. The adhesive is not required to necessarily exhibit any pressure-sensitive adhesive functionality after being hardened; in other words, the adhesive may be a non-tacky, e.g. hard, material after being hardened.

A hot-melt adhesive for use herein may comprise any suitable thermoplastic organic polymeric composition, whether based on e.g. a homopolymer, a copolymer, a blend of multiple homopolymers and/or copolymers, and so on. Many potentially suitable hot-melt adhesive compositions are based on e.g. ethylene-vinyl acetate polymers, polyolefins (e.g. polyethylene, polypropylene, and copolymers thereof), polyamides, and/or blends thereof. Other materials, additives, and so on, may be present, e.g. any of various tackifiers, resins, waxes, plasticizers, and so on. Many suitable hot melt adhesives comprise one or more base materials (e.g. polymeric materials) blended with significant amounts of other components (such as e.g. organic waxes) to reduce the melting point and/or the melt viscosity of the mixture so that it can be processed with hot-melt adhesive-dispensing equipment (e.g. grid-melters and metering pumps). Hot melt adhesives may also often comprise components such as tackifiers to increase the tackiness of the mixture. Exemplary hot melt adhesives are disclosed in U.S. Pat. No. 7,235,115. For example, one representative hot melt adhesive is Hot Melt Adhesive 3748, available from 3M Company, St. Paul, MN, which is disclosed as including polypropylene, polyethylene, ethylene-propylene polymer, styrene-butadiene polymer, and polyolefin wax. It will be appreciated that many other potentially suitable compositions are available.

Any such adhesive may be deposited on front pleat walls in any suitable manner, using any suitable apparatus and/or method. As noted earlier herein, in some embodiments, the deposition of adhesive may be done with the pleated media in an at least semi-expanded or even nearly-flat condition. The media can then be compacted so that the parcels of adhesive are each in contact with local areas of adjoining front pleat walls; the adhesive can then be hardened so that bonds are established between the local areas of the front pleat walls to form junctions. In some embodiments, the adhesive deposition may use apparatus and methods of the general type described in U.S. Pat. Nos. 7,896,940 and 8,419,817, noting that these documents do not disclose deposition of adhesives in a manner (e.g. in parcels that are spaced and offset) that would provide a diamond-pleated media.

### Expansion of Diamond-Pleated Media

The presence of junctions 20 will provide that a diamond-pleated media, once formed, cannot be expanded to a completely planar, sheet-like state. That is, the presence of the junctions will eventually limit any further expansion of the media in the expansion direction (unless such force is applied as to rupture the junctions, which would not qualify as ordinary use of the diamond-pleated media in the manner disclosed herein). However, the junctions 20 may nevertheless allow a rather large expansion to be performed. Thus in various embodiments, a diamond-pleated filter media may exhibit an expansion ratio of at least 2, 3, or 4. In further embodiments, the media may exhibit an expansion ratio of at most 8, 6 or 5. Such a ratio will be a ratio of the total span of the media (along the expansion direction) in the expanded state to its total span in the compacted state.

In some embodiments, a diamond-pleated media may be configured to be expanded to a maximum span as limited by the junctions (again, the term “span” denotes the overall extent of the media along the expansion dimension: the term “breadth” denotes the overall extent along the pleat direction). Thus for example, a diamond-pleated media may be provided in a compacted configuration in which it has a span of 4 inches and a breadth of 16 inches, and is configured to be expanded to its maximum possible span of 20 inches (thus exhibiting an expansion ratio of 5), so as to be used as a nominal 20″×16″ air filter. In some embodiments, a diamond-pleated media may be configured so that it can be expanded to one or more spans that are less than the maximum span. Thus, in the above example, the diamond-pleated media may be able to expand to a span of e.g. 10 or 16 inches, so that it can be used as a nominal 10″×16″ or 16″×16″ filter. It is thus evident that the herein-disclosed expandability can allow considerable flexibility in sizing filters to fit appropriate needs. The Working Examples also reveal that while there is typically some variation in filtration performance depending on the degree to which the diamond-pleated filter media is expanded, this variation is rather limited, and the media has been found to perform very well over a variety of expansion conditions.

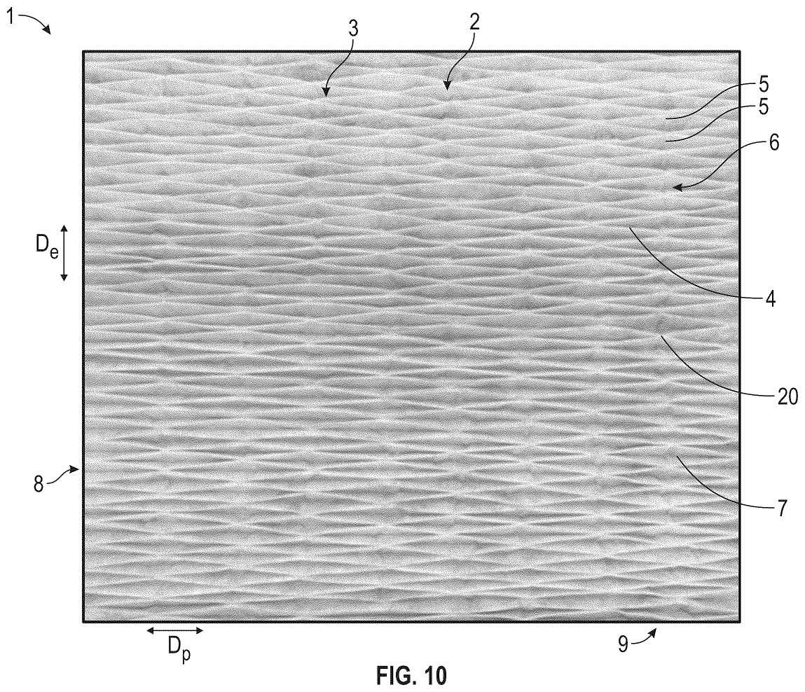

The properties of diamond-pleated filter media have so far been described with reference to the exemplary arrangements depicted in FIGS. 5-7. It is emphasized that these are idealized representations. FIG. 10 presents a photograph of the front side of an actual Working Example diamond-pleated filter media. Various features and components of the Working Example diamond-pleated filter media are pointed out on FIG. 10, and correspond to their counterparts in the idealized representations of FIG. 5-7. As evident in FIG. 10, in actual products, there may be occasional slight deviations, statistical variations, and so on, from the idealized patterns shown in FIGS. 5-7. For example, rather than junctions 20 being present more or less in the form of “points” as seemingly indicated in FIGS. 5-7, in actuality such junctions may have finite “widths” (along the pleat direction), e.g. corresponding to the “widths” along the pleat direction, of the adhesive parcels used to form the junctions.

Based on the above discussions it will be appreciated that when a diamond-pleated filter media is in a compacted configuration, the adjoining front pleat walls 5 of each front pleat 3 will be in close abutment with each other along their entire length in the pleat direction, so that the front pleat valleys 6 are substantially collapsed. Similarly, for each rear pleat, adjoining rear walls of the rear pleats will be in close abutment with each other along their entire length along the pleat direction, so that the rear pleat valleys are substantially collapsed. When the diamond-pleated media is expanded along the expansion direction, the adjoining front walls of each front pleat will become spaced apart from each other in the expansion direction. This will occur by way of the adjoining front walls partially rotating away from each other around a common rotation axis that is aligned with the front pleat valley at which the adjoining front pleat walls are connected. This outward movement of the adjoining pleat walls will take place except at the above-described junctions, at which junctions the local areas of the adjoining front pleat walls of each front pleat will remain frontally joined together thus preventing the front pleat walls from separating from each other and expanding. As discussed in detail earlier herein, these arrangements provide the desired diamond-pleated media in which the front side exhibits upwardly-open-ended pockets.

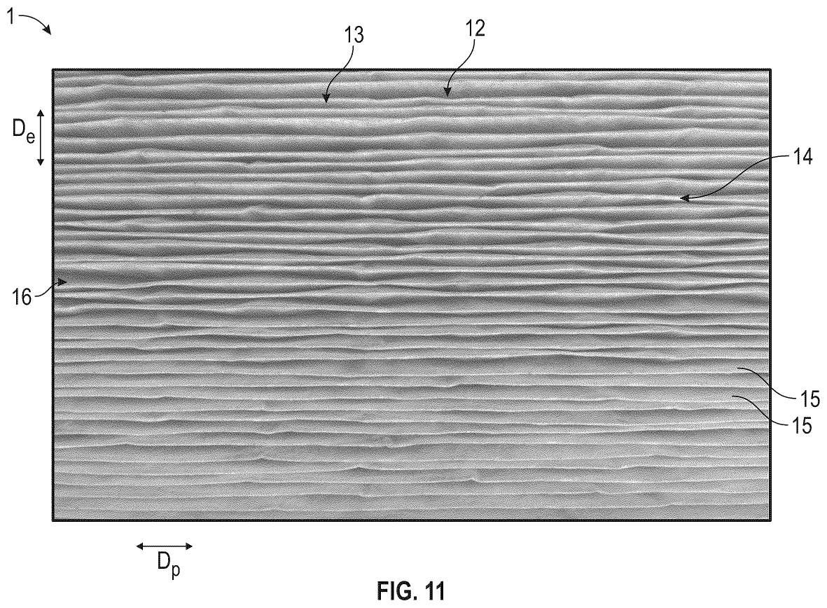

In some embodiments, the rear side 12 of the diamond-pleated filter media will not comprise any junctions at which local areas of adjoining rear pleat walls of any rear pleat are rearwardly joined together. This will have the effect that when the diamond-pleated filter media is expanded from a compacted configuration to an expanded configuration, no areas of the adjoining rear pleat walls will be constrained from moving away from each other in the manner that the joined local areas of the front pleats are constrained. Thus, in at least some embodiments, upon expansion of the diamond-pleated media the rear side 12 of the media may not form pockets of the type found on the front side 2 of the media. Rather, the rear pleat tips 14 may remain in an at least quasi-linear arrangement across the entire span of the media from one corrugated edge to the other, as evident in the photo of the rear side of a Working Example diamond-pleated filter media shown in FIG. 11. (In some instances, a faint echo or imprint of the front-side pleat arrangement, with its pockets, may be visible from the rear side of the media.) In other embodiments, local areas of rear pleat walls 15 of rear pleats 14 may be joined together in similar manner as described for local areas 50 of front pleat walls 5. In such cases, the rear side 12 of the pleated media may exhibit a diamond-pleated pattern e.g. with rearwardly-open-ended pockets and so on.

In some embodiments, one or more support members may be provided at least on what will become a downstream side of the diamond-pleated filter media 1. (In many embodiments, but not necessarily, this downstream side will correspond to the “rear” side of the diamond-pleated filter media, as discussed elsewhere herein). Any such support members of this type will be permanently bonded to at least the downstream pleat tips of the pleated media and are thus permanently resident on the pleated media itself. As such, such support members are distinguished from, e.g. downstream support members as may be present on a support frame into which the pleated media is installed, as discussed later. In some embodiments, such support members may be provided on what will become the upstream side of the diamond-pleated filter media.

If present, such support members may take the form of relatively wide ribbons or strips of material that oriented at least generally along the expansion direction of the pleated media. Or, they may take the form of individual filaments that are e.g. extruded onto the pleat tips of the pleated filter media. Other possibilities include the use of filaments in the form of a pre-existing scrim that includes filaments oriented in a wide variety of directions; wire filaments that are bonded at least to the pleat tips, and so on. In some cases, any such support members may be disposed only in contact with pleat tips; in other cases, any such support members (e.g. wire mesh) may be pleated along with the media. However, in some embodiments, no support members of any kind (in particular, that are bonded to at least pleat tips of the media) may be provided along with the diamond-pleated media.

Pleated filter media 1 may rely on any suitable filter media 100 (reference number 1 denotes any such media 100 that has been pleated). Potentially suitable materials may take any form including e.g. nonwovens, such as meltblown or spunbond webs of synthetic or natural fibers; scrims; woven or knitted materials and so on. Any suitable method of making a nonwoven web (e.g., melt-blowing, melt-spinning, air-laying, carding, and so on) may be used. Filter media 100 may also include sorbents (e.g., activated carbon), catalysts, and/or any other desired additive (whether in the form of e.g. granules, fibers, coatings, fabric, and molded shapes).

Multilayer media, e.g. laminated media, can also be used as filter media 100. Such media may consist of laminated layers of the media discussed above or of other substrates laminated to one or more layers of filter media, for example. In some embodiments, a prefilter layer may be used on the upstream side of filter media 100. Such a prefilter layer may comprise e.g. polypropylene, polyethylene, polyethylene terephthalate, poly(lactic acid), or blends of these materials. In other words, in some embodiments filter media 100 may comprise at least one air-filtration layer along with any other layer or layers as desired for any purpose. For example, a stiffening layer may be laminated to an air-filtration layer (e.g. a melt-blown layer) that, by itself, is not easily pleatable. Such a stiffening layer may enhance the pleatability of the material and may or may not contribute significantly to the actual filtration achieved by the multilayer media. In some embodiments, filter media 100 may comprise two layers of similar, nearly-identical, or identical layers of e.g. meltspun fibers, deposited in succession so as to form a single, unified filtration media.

In some embodiments, the filter media includes polyolefinic fibers (e.g. polyethylene, polypropylene and copolymers thereof). In some specific embodiments, a filter media comprises, or consists essentially of polypropylene fibers (noting that this latter conditions does not preclude the presence of e.g. electret moieties, and/or processing additives, UV stabilizers and so on, as are customarily used with polypropylene). In various embodiments, a nonwoven web (e.g. a spunbond or meltblown web) comprised of, or consisting essentially of, polypropylene homopolymer fibers may be used.

In specific embodiments, filter media 100 may be an electret material, comprised of e.g. any charged material, e.g. split fibrillated charged fibers as described in U.S. Pat. No. RE 30782. Such charged fibers can be formed into a nonwoven web by conventional means and optionally joined to a scrim such as disclosed in U.S. Pat. No. 5,230,800 forming an outer support layer. In other specific embodiments, filter media 100 can be a melt blown microfiber nonwoven web, e.g. such as disclosed in U.S. Pat. No. 4,813,948, which can optionally be joined to a secondary layer during web formation as disclosed in that patent, or subsequently joined to a secondary web in any conventional manner. Filter media that may be particularly suitable for certain applications might include e.g. media of the general type described in U.S. Pat. No. 7,947,142 to Fox; media of the general type described in U.S. Patent Application Publication 20080038976 to Berrigan; and, media of the general type described in U.S. Patent Application Publication 20040011204 to Both, and media generally known as tribocharged media. Any such media can be charged to form an electret, if desired.

In various embodiments, any such filter media 100 may exhibit a thickness of less than about 2.0, 1.5, 1.2, 1.0, 0.8, 0.6, 0.5, or 0.4 mm. In various embodiments, any such filter media may exhibit a basis weight of from at least about 10, 20, or 30 grams per square meter (g/m2), to at most about 180, 120, 100, 80, or 60 g/m². In various embodiments, the media may exhibit a pressure drop that is greater than about 1.0, 2.0, or 4.0 mm of water (measured according to the procedures disclosed in U.S. Patent Application Publication 2016/0206984). In further embodiments, the media may exhibit a pressure drop that is less than about 20, 15, 10, or 8 mm of water. In various embodiments, the media may exhibit a Minimum Efficiency Report Value (MERV), measured according to the procedures disclosed in U.S. Patent Application Publication 2016/0206984, of at least 5, 9, 11, or 13. In various embodiments, the media may exhibit a Dust Holding Capacity, measured according to the procedures disclosed in the Working Examples of U.S. Patent Application 2021/0229012 of at least 15, 20, 25, 30, or 35 grams per square meter. (Pressure drop, MERV, and Dust Holding Capacity will be measured with the media in its final, end-use, pleated configuration.)

In some embodiments, e.g. in order to be achieve and maintain a relatively tightly pleated configuration, the input filter media 100 (and the resulting diamond-pleated filter media 1) may comprise a relatively high stiffness. In some embodiments, the stiffness of the media may be characterized by a Gurley Stiffness (measured as described in U.S. Patent Application Publication No. 2022/0266180, which is incorporated by reference herein for this purpose). In various embodiments, filter media 100 may exhibit a Gurley Stiffness of greater than 100, 150, 175, 200, 225, 250, or 300 mg. In further embodiments, the filter media may exhibit a Gurley stiffness of less than 100000, 10000, 1000, 500, 400, 350, or 275 mg.

In particular embodiments, the filtration media may be a meltspun, spunbond nonwoven web of the general type disclosed in U.S. Pat. No. 7,947,142. Such a spunbond media may advantageously exhibit a relatively high stiffness and may be particularly amenable to maintaining a tightly-pleated configuration. In other particular embodiments, the filtration media may be a meltblown (BMF) nonwoven web of the general type disclosed in U.S. Pat. No. 8,142,538. Such a meltblown media may similarly exhibit a relatively high stiffness and may be particularly amenable to maintaining a tightly-pleated configuration.

In some embodiments, a pleated filter media 1 may be self-supporting. By this is meant that the pleated filter media, when placed in a conventional perimeter-holding fixture of a forced-air HVAC system without any kind of support on the downstream side of the pleated filter media (in other words, so that the pleated media is supported around its perimeter edges only), is able to withstand the forces developed when air impinges on the upstream face of the pleated filter media so as to develop a pressure drop of 0.2 inches of water when tested in the manner described in U.S. Pat. No. 9,174,159, which is incorporated by reference in its entirety herein for this purpose. By able to withstand such forces means that the pleated filter media does not collapse, deform, become dislodged, rupture, or the like, so as to render the performance of the filter media unsatisfactory.

### Frames

In some embodiments, a diamond-pleated filter media 1 as disclosed herein can be installed in a reusable support frame to form a framed filter assembly that can then be inserted e.g. into an air-handling apparatus or system such as an HVAC system or a room air purifier. For example, the diamond-pleated filter media may be provided in a compacted configuration (e.g. it may be included in a kit that has multiple such compacted filter media); an end user can then expand the diamond-pleated filter media to the appropriate size to be installed into a particular support frame. Any suitable support frame may be used. Some such frames may provide only perimeter support, while others may additionally provide support at least on the downstream side of the filter media, e.g. in the form of a lattice of support members.

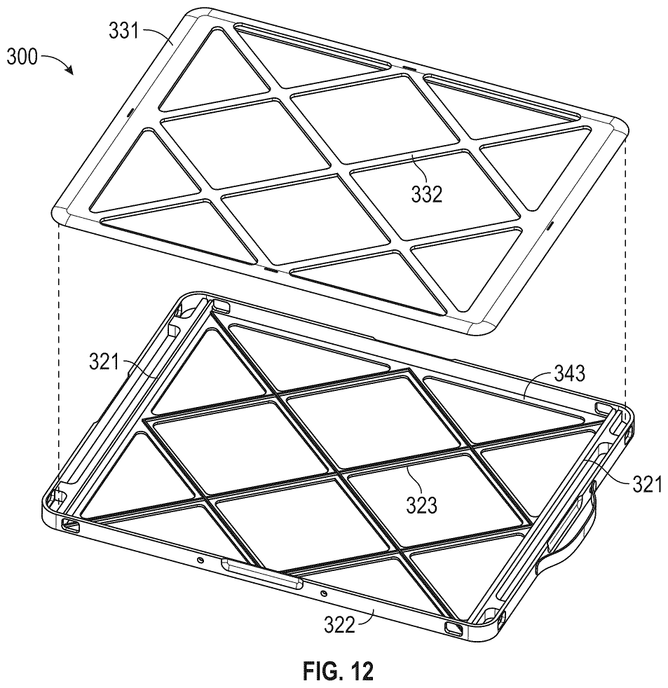

FIG. 12 depicts one such exemplary reusable support frame 300 in perspective exploded view. The depicted arrangement is one in which support frame 300 comprises a main body 322 and a cover 331 that is mateable to main body 322 to provide a space to accommodate the filter media, with both main body 322 and cover 331 providing perimeter support for the filter media. In some embodiments, such an arrangement may take the form of a “clamshell” design in which cover 331 is hingedly attached to main body 322 so that cover 331 may be rotated to an open position to allow a pleated filter media to be inserted into the space. In other embodiments, such an arrangement may be a “two-part” design in which cover 331 is completely separable from main body 322 (as in the exemplary design of FIG. 12). Cover 331 may be held in place on main body 322 by any suitable mechanism, arrangement, latch(es), clip(s), fastener(s), and so on. Any such support frame (whether, e.g., clamshell or two-part) will typically be produced in the factory and provided to an end-user who can open the frame to install a filter media thereinto. In some embodiments, the frame may be provided in pieces that are assembled by an end-user to form the frame. In some embodiments, such a support frame may comprise one or more downstream support members as exemplified by the lattice of support member 323 depicted in FIG. 12. The exemplary design of FIG. 12 also provides support members 322 on the upstream side (as part of cover 331), although such upstream support may not be needed in all cases.

The exemplary support frame 300 shown in FIG. 12 also comprises features that can enhance the ease and security with which a diamond-pleated filter media 1 may be installed in frame 300. These features include exemplary slots 321, which are provided at opposing ends of the frame along what will be the expansion direction of the filter media as installed in the frame. The slots 321 are elongated in a direction that will correspond to the pleat direction of the pleated media as installed in the frame, and are upstream-open-ended. To facilitate installation into such a frame, a diamond-pleated filter media 1 may make use of first and second end panels at the opposing non-corrugated ends 9 of the media. Each end panel may be seated into a respective slot 321 of frame 300 to install the filter into the frame to form a framed filter assembly. The receiving of end panels of the pleated filtration media into complementary elongate, upstream-open-ended slots 321 of a support frame can allow the pleated filtration media to be held in place on the frame in spite of any force exerted on the filtration media by the impinging of flowing fluid (e.g. air) onto the upstream surface of the filter media. In some embodiments, each such end panel of the pleated media may be reinforced e.g. to render it stiff and rigid, so as to further enhance the security with which the end panel is held within the elongate slot of the frame. Methods for achieving this are discussed in U.S. Provisional Patent Applications 63/426,447 and 63/452,484, and in the resulting International (PCT) patent application number PCT/IB2023/061115, all of which are incorporated by reference herein in their entirety.

The exemplary support frame 300 as depicted in FIG. 12 also includes downstream support flanges 343 along two sides of the support frame. In some embodiments, a diamond-pleated filter media 1 may be installed in such a frame so that the corrugated edges 8 of the filter media are closely abutted against (e.g. in contact with) an inward surface of the frame sidewall. The downstream pleat tips of the corrugated edges of the pleated filter media may be supported by downstream support flanges 343.

It is emphasized that the particular frame shown in FIG. 12 is merely a representative example and that any kind of frame may be used. These may be chosen from the style of frame generally referred to as channel frames, the style generally referred to as pinch frames, and so on. Again, any such frame may or may not be reusable, may be e.g. one-piece (e.g. clamshell) or two-piece, and so on.

Throughout this document, the terminology of front and rear sides and components of pleated filter media has been used. By a front side is meant a side in which local areas of adjoining pleat walls that face toward each other across pleat valleys are joined together (e.g., by an adhesive) to form junctions. It is emphasized that this terminology is used for convenience of description. In many embodiments a diamond-pleated filter media (e.g., as installed in a reusable frame) may be positioned in an air-handling apparatus so that the front side of the filter media (i.e., the side with junctions) is the upstream side (i.e., the side that moving air impinges on) and the rear side is the downstream side (from which filtered air exits the filter media). However, this does not necessarily need to be the case. In fact, the Working Examples demonstrate that in at least some cases, a diamond-pleated filter media can perform satisfactorily with the rear side of the media facing upstream. Thus, the descriptive terminology as used herein does not limit the orientation of a diamond-pleated filter media in actual use. It is further noted that in some embodiments, the herein-disclosed forming of junctions may be performed on both sides of the pleated media, in which case it may be arbitrary as to which is considered the front and which is considered the rear.

The exemplary depiction of FIG. 12 presents a support frame that is configured to accept a pleated filter media whose dimension in the expansion direction is greater than its dimension in the pleat direction. However, in some embodiments a diamond-pleated filter media may be configured opposite to this (and may be used with a support frame configured to accept such a filter media). That is, in some embodiments a diamond-pleated filter media may be configured so that its dimension in the pleat direction is greater than its dimension in the expansion direction. (The exemplary Working Example sample of diamond-pleated filter media shown in the photograph of FIGS. 10 and 11, is one such case.)

In some embodiments, the entire area of a diamond-pleated filter media may be at least generally uniform, e.g. in terms of the spacing of the junctions 20, size and shape of pockets 30, and so on. However, in some embodiments, one or more end or edge regions of a diamond-pleated filter media may be configured in a particular manner. For example, at the non-corrugated ends 9 of the filter media, several end panels (pleat walls) may be gathered together (accordionized) and attached to each other to form a reinforced end panel (that is, e.g. suitable for inserting into a receiving slot of a frame). In the event that such arrangements cause one or more end or edge regions near a perimeter edge of the media to be configured differently than the main, interior area of the media, any of the previously-mentioned properties (e.g. vertex angle, pocket width, etc.) will be measured within the main, interior area. In particular, certain conditions outlined elsewhere herein (e.g., that locations in between junctions 20 are to be expandable along the pleat direction) will be understood as not being applicable to, e.g., a set of gathered/attached end panels of the media.

Within the guidelines provided herein, numerous variations are possible. For example, the joining of local areas 50 of front pleat walls to form junctions does not necessarily have to be performed using adhesive. Rather, in various embodiments, such local areas can be joined to each other e.g. using melt-bonding methods such as ultrasonic welding, using mechanical bonding methods such as stapling (or, in general, the use of mechanical fasteners of any type), and so on.

Further, the junctions 20 do not necessarily have to be provided in a uniform array such that the diamond-pleated media exhibits pockets 30 that are all uniform in size and shape. Rather, the junctions can be spaced (and/or the offset distances between junctions in various pleats can be chosen) so that the lengths and/or widths of the pockets 30 differ in different regions of the diamond-pleated media. For example, the pockets may be larger toward the geometric center of the media than toward the edges, or vice versa.

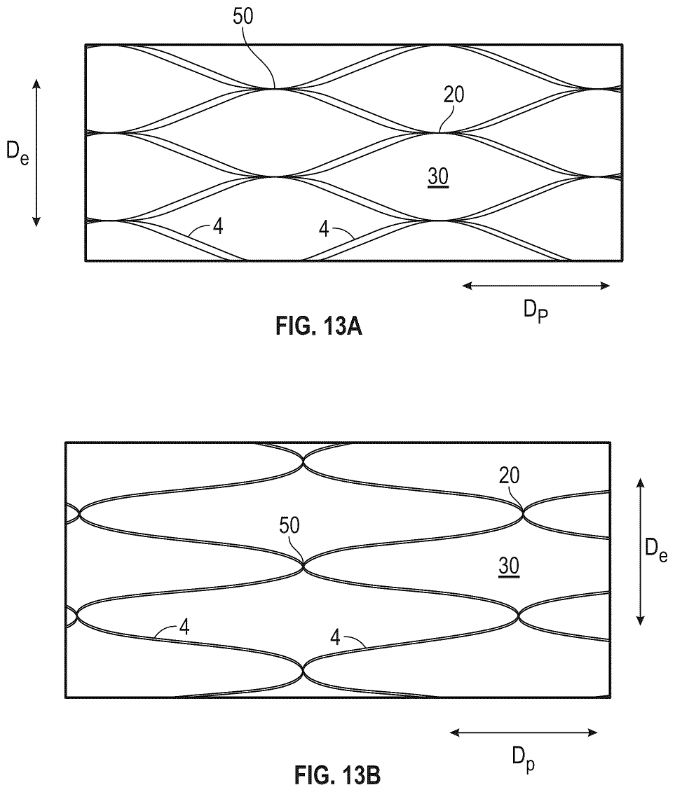

Still further, the front pleat tips and associated front ridges that define pockets 30 do not necessarily have to take the form of a collection of end-to-end connected line segments that extend strictly linearly and uniaxially between junctions 20. Rather, in some embodiments these segments may exhibit at least some curvature. Such arrangements are illustrated in exemplary manner in FIGS. 13a and 13b, which are front plan views of other exemplary designs of diamond-pleated media (in these exemplary depictions, only the front pleat tips 4 and junctions 20 are explicitly shown, although it is readily apparent where the pockets 30 of the media will be).

The use of designs in which front pleat tips and their associated front ridges are the form of e.g. arcuate segments having been explored and encompassed in the present work, it is emphasized that the terminology of diamond-pleated media is used for convenience of description and does not require that a diamond-pleated filter media must necessarily comprise front pleat tips that have strictly linear and uniaxial segments between junctions 20 and thus does not require that a diamond-pleated media must exhibit pockets 30 that are strictly in the form of perfectly straight-sided rhombuses. Rather, pleating patterns with curvilinear segments between junctions may be used, e.g. tessellated patterns comprising “tiles” of any suitable (e.g. non-polygonal) shape, as evidenced by FIGS. 13a and 13b.

Still further, in some embodiments a diamond-pleated media may comprise pockets that have a length to width aspect ratio approaching 1:1. Such an arrangement will differ from some arrangements described earlier herein, in that the media may be significantly expandable along two, e.g. generally orthogonal axes, rather than being expandable along an expansion direction Dₑ and being generally non-expandable along a pleat direction D_{P} in the manner discussed earlier herein.

It is noted in passing that as mentioned earlier herein, junctions 20 as formed by joined local areas 50 of front pleat walls 5 may be, and often will be, located just slightly away from (i.e., rearward down the front pleat walls from) the actual front pleat tips 4, rather than being exactly at, or including, the front pleat tips 4. It is thus emphasized that FIGS. 13a and 13b (and previously-discussed FIGS. 5-7) are exemplary, idealized representations. It will thus be appreciated that any language herein referring to junctions 20 as being “at” pleat tips, “of” pleat tips, “with” pleat tips, “between” pleat tips, or similar language, is used for convenience of description. This language does not imply that such junctions 20 (in particular, their joined local areas 50) must encompass the pleat tips. Rather, in many cases, the joined local areas 50 may be located e.g. near the pleat tips 4, without actually encompassing the pleat tips 4, as discussed in detail earlier herein.

Other possible variations lie in the mode of use of the diamond-pleated filter media. Although discussions above have primarily concerned providing the diamond-pleated filter media in a compacted state so that it can be expanded and installed into a support frame (e.g. a reusable support frame), other modes of use are possible. For example, in some embodiments the diamond-pleated filter media may be installed directly into an air-handling apparatus or system (e.g. a room air purifier or an HVAC) without the filter media having been fitted with a support frame. For example, previously-mentioned reinforced end panels of the diamond-pleated filter media may be seated into elongate slots provided in an air-handling apparatus. In some embodiments a diamond-pleated air filter media may be conformable into an arcuate shape, e.g. so as to be installed into an arcuate frame and/or so as to be supported by an arcuate filter-support layer of an air-handling apparatus in the general manner disclosed in U.S. Patent Application Publication 2018/0021716, which is incorporated by reference in its entirety herein. It will be appreciated that any suitable method of installation may be used, relying e.g. on any suitable clips, fasteners, and the like, to install the filter media into a suitable fixture or support of an air-handling apparatus.

Still further, although a significant virtue of the herein-disclosed diamond-pleated filter media is the above-discussed expandability from a compacted configuration, the diamond-pleated filter media, when in an expanded condition, displays a unique appearance that is quite aesthetically attractive. Thus in some embodiments a diamond-pleated filter media may be provided to an end-user already in an expanded condition, e.g. in a frame in which the diamond-pleated filter media has been factory-installed. In a further variation of this type, such a diamond-pleated filter media, as provided in an expanded configuration, may be configured so that it is not compactable into a compacted configuration.

FIGS. 13a and 13b illustrate another general category of diamond-pleated media that is encompassed within the disclosures herein. Namely, diamond-pleated patterns e.g. of the general type shown in FIGS. 13a and 13b need not be made by the procedures described earlier herein, in which a precursor, linearly-pleated media is processed to join local areas of the front pleats together (e.g. by adhesive bonding) to form junctions, so as to deform the front pleat tips and ridges away from their original straight configuration into a diamond-pleated pattern in which each front pleat tip and ridge is in the general shape of a zig zag. Rather, in some embodiments, a diamond-pleated media may be formed by some method other than deforming the pre-existing front pleat tips, ridges, and walls of a linearly-pleated input media. For example, in some embodiments a diamond-pleated media may be formed directly, e.g. by impinging nonwoven fibers onto a collection surface that collects the nonwoven fibers directly into the desired shape as they land on the collection surface. In such embodiments, a patterned or three-dimensionally shaped collection surface (rather than, e.g., a uniformly flat or uniformly semicylindrical, one-dimensionally-arcuate collector as is conventionally used in collection of e.g. meltspun or meltblown nonwoven fibers) may be used. Such a collection surface might use, e.g., a variation of the arrangements described in U.S. Pat. No. 9,771,675 and in U.S. Patent Application Publication 2011/0250378. (Such fibers, as collected, may be consolidated into a coherent web by any suitable means.)

Thus in some embodiments, a diamond-pleated filter media may be directly formed e.g. by the direct collection of nonwoven fibers. In some embodiments, a directly-formed diamond-pleated filter media may take the general form illustrated in FIGS. 5-7 and described in detail earlier herein. However, direct formation, e.g. by direct collection of nonwoven fibers, allows the generation of other shapes and geometric arrangements, as exemplified by FIGS. 13a and 13b. In diamond-pleated media of the general type shown in FIGS. 13a and 13b, junctions 20 will be present, and will serve the same function previously described, of holding local areas of front pleat walls together so as to prevent these local areas from separating away from each other when the media is expanded along the expansion direction. However, these junctions will be directly formed in the collecting of nonwoven fibers to form the media, rather than being formed by joining two pre-existing front pleat walls to each other. Such junctions and the resulting diamond-pleated media are encompassed by the disclosures herein.

In still other embodiments, a diamond-pleated filter media may be produced by taking a flat filter media and deforming the flat filter media into a diamond-pleated configuration by other means than conventional pleating following by bonding of local areas. Thus for example, a flat filter media might be thermoformed into a diamond-pleated configuration by heating the flat filter media and vacuum-forming the flat filter media against a suitable three-dimensionally-surfaced vacuum-forming mold, or by forming the media between three-dimensionally-surfaced male and female forming tools.

It will thus be appreciated that the present disclosure is directed to the formation of “pleated” media with specific features (e.g., junctions), geometric properties and so on, that can provide the ability to expand from a compacted configuration to an expanded configuration in which the media exhibits frontwardly-open-ended pockets and so on. It will thus be understood that the terminology of diamond-pleated media does not imply anything about the particular method of forming the diamond-pleated media; in particular, it is not limited to entities that are made by, or derived from, media-folding operations in the conventional sense of “pleating”. Rather, media that is generated in other ways, e.g. by being directly formed into a desired geometric pattern and shape during the process of collecting nonwoven fibers, is encompassed within the concept of a diamond-pleated media. Thus in particular, a junction as defined herein, as provided by joined local areas of front pleat walls, is not limited to areas of pre-existing front pleat walls that are subsequently joined together (e.g. by an adhesive or via melt-bonding). Rather, this concept also encompasses arrangements in which local areas of front pleat walls are joined by virtue of comprising fibers that are entangled with and/or bonded to each other in the act of collecting and/or consolidating the fibers.

A diamond-pleated filter media 1 as disclosed herein (e.g., as installed in a reusable support frame to form an air filter assembly) may be used in any suitable environment or situation in which moving air, e.g. motivated by a mechanized fan or blower system, is desired to be filtered. Media 1 thus may find use e.g. in HVAC (heating-ventilating-air-conditioning) systems, room air purifiers, automotive engine or cabin-air filtration applications, filtration of air in the vicinity of sensitive electronic devices, and so on. In particular embodiments, diamond-pleated filter media as disclosed herein may be configured for use in forced-air HVAC systems such as in residences, offices, and the like (noting that the term HVAC (heating-ventilation-air-conditioning) encompasses systems that perform only heating, only cooling, or both). A diamond-pleated filter media may be the only filter that is used; or, it may serve as a primary filtration layer of a multiple-filter stack, or as a prefilter of a multiple-filter stack, etc.

The joining of local areas of front pleat walls together to form junctions in the manner disclosed herein has been found to not significantly affect the performance of the filter media in air filtration, whether characterized by pressure drop, capture efficiency, or any other parameter by which such performance is customarily judged, as evidenced in the Working Examples herein. Thus, a diamond-pleated filter media can provide the advantages disclosed herein without requiring any trade-off or sacrifice in filtration properties.

It has also been found that when a diamond-pleated media is expanded from a compacted to an expanded configuration as described herein, the expansion tends to be relatively uniform throughout the expansion direction (and pleat direction) of the media. (In other words, all of the pockets tend to expand together, in unison, rather than e.g. those toward the non-corrugated ends of the media expanding first, while those toward the center of the media remain compacted.) This is in contrast to some arrangements e.g. using externally-added members (e.g. ribbons) to govern the pleat spacing, for which the expansion sometimes can be non-uniform along the expansion direction.

Although discussions herein have primarily concerned filtration of air, a diamond-pleated filter media as disclosed herein may be used for the filtration of any fluid, whether gaseous or liquid or a mixture such as a slurry, airborne dispersion, and so on. Thus in various embodiments, a diamond-pleated filter media may be used for filtration of water, motor oil, and any other fluid that is desired to be filtered. Similarly, although discussions herein have primarily concerned uses in which the diamond-pleated filter media is maintained in a flat configuration, this need not necessarily be the case. For example, it was mentioned above that in some embodiments a diamond-pleated filter media may be conformed into an arcuate shape e.g. so that the filter media may be positioned on an arcuate filter-support layer of an air-handling apparatus. Beyond this, in some embodiments a diamond-pleated filter media may be formed into a generally cylindrical shape, e.g. by joining the non-corrugated ends 8 of the diamond-pleated filter media together. Thus in some embodiments, a diamond-pleated filter media may be used in the form of a generally cylindrical cartridge filter or in some such similar format.

### EXAMPLES

### Test Methods

### Pressure Drop, E1-E3, MERV, Dust Holding

Initial pressure drop, E1-E3 Capture Efficiency values, and Minimum Efficiency Reporting Value (MERV) were obtained via apparatus and procedures of the general type described in U.S. Patent Application Publication 2016/0206984, which is incorporated by reference in its entirety herein. (The particular particle counter used in these evaluations was a MetOne3400 instrument of the type available from Beckman Coulter.)

The Dust Holding Capacity was evaluated via apparatus and procedures of the general type described in U.S. Patent Application Publication 2021/0229012, which is incorporated by reference in its entirety herein. The Dust Holding Capacity is normalized to the pleated filter face area and is reported in grams per square meter.

### WORKING EXAMPLES

### Formation of Precursor Webs

Filter media in the form of a spunbonded web was obtained. The meltspun fibers were monocomponent polypropylene fibers made and collected in general accordance with the procedures described in U.S. Pat. No. 7,947,142. The collected fibers had been autogenously bonded to form coherent, spunbonded webs in general accordance with the procedures described in U.S. Pat. No. 9,976,771. The webs had been hydrocharged in the general manner described in U.S. Patent Application Publication 2012/0017910. The webs exhibited a basis weight of approximately 70 grams per square meter, and exhibited a Gurley stiffness (measured in general accordance with the procedures described in U.S. Patent Application Publication 2022/0266180) of approximately 250 milligrams.

The filter media was obtained as a “flat” web (in roll form) and was scored and pleated using conventional web-pleating apparatus and methods. The web was pleated so as to comprise a pleat distance of approximately 1.63 cm (0.64″) so that the web could be folded so as to exhibit a pleat height of approximately 1.57 cm (0.62″) and a pleat spacing of approximately 0.73 cm, corresponding to a pleat frequency of 3.5 pleats per inch or 1.4 pleats per cm. (Some samples were folded to other pleat heights and pleat spacings, as discussed later.)

### Deposition of Adhesive

The resulting media was a linearly-pleated media which was used as a precursor to make diamond-pleated media. To do this, the linearly-pleated media was held in a slightly-expanded condition (in relation to the final pleat spacing of the resulting diamond-pleated media) and parcels of hot melt adhesive were deposited onto selected areas of one surface (that would become the “front” surface) of the media. The adhesives that were used included Hot Melt Adhesive 3748Q available from 3M Company and PERMACLEAR 124-25-2 available from Tailored Chemical Products. The adhesive parcels were deposited manually, using a hand-held hot-melt adhesive deposition apparatus obtained from Reka Klebetechnik under the trade designation MS80. Depositions were typically carried out with the internal mesh pot of the apparatus operating at 120 to 180 degrees C. The hot melt adhesives that were used exhibited sufficient open time (typically in the range of 10-15 seconds) that the adhesive parcels could be deposited in rows along pleats as described below. After a row of adhesive parcels was deposited on a pleat wall (at the appropriate spacings between individual parcels along the pleat direction), the pleat was manually compressed along the length of the pleat by the use of an elongate block that was manually urged against the pleat walls to urge them together. The pleat was held in this condition for sufficient time for the adhesive parcels to harden, thus forming junctions between the pleat walls of the type described earlier herein. The same procedure was then carried out for the next, nearest-neighbor pleat (with the adhesive parcels being deposited on this next pleat in locations that resulted in the formation of offset junctions as described herein). The procedure was continued pleat by pleat until junctions had been formed in the desired number of pleats.

In most experiments, the adhesive parcels were deposited in an amounts targeted at nominal range of approximately 0.035-0.045 grams of adhesive per locally-bonded area. The above-described manual compression caused each adhesive parcel to contact, and be compressed between, complementary local areas of adjoining front pleat walls. The adhesive was thinned from its as-deposited thickness to a final thickness as a result of this compression between the pleat walls. It was estimated that in these experiments, the hardened adhesive parcels (and the resulting spacing between the local areas of front pleat walls at the junctions) exhibited a thickness that was, for the most part, in the range of 0.5-1.5 mm. The adhesive also tended to spread slightly as a result of the compression; this was taken into account so that the adhesive, in its final, hardened form, occupied a desired local area of each pleat wall. In particular, the adhesive was deposited to minimize any chance of the adhesive spreading to within approximately 1.0 mm of the pleat tips. (It will be appreciated of course that with this manual deposition, there were occasional variations in the deposition amount, location, thickness, and so on, of the adhesive parcels.)

### Arrangement of Adhesive Parcels

The adhesive parcels were deposited to form an arrangement of the general type depicted in FIG. 8, in “rows” and “columns”. In this context, a “row” is a set of adhesive parcels spaced along a pleat in the pleat direction. Thus, one row of adhesive parcels would include the items marked 40_{a-b} and 50_{a-b} of pleat 3_{a-b} in FIG. 8; a different row of adhesive parcels would include the items marked 50_{b-c} and 40_{b-c} in pleat 3_{b-c} of FIG. 8. A “column” is a set of adhesive parcels spaced along the media in the expansion direction, such as the set including the items marked 40_{a-b} and 40_{g} in FIG. 8. In Representative Working Example samples, the adhesive parcels were spaced along each pleat at a spacing of approximately 12.7 cm (5.0 inches); thus, for example, items 40_{a-b} and 50_{a-b} in FIG. 8 would be 12.7 cm apart; similarly, items 40_{b-c} and 50_{b-c} would be 12.7 cm apart. The successive rows of adhesive parcels were staggered (at approximately 6.4 cm spacing) in the general manner shown in FIG. 8. Thus, each “column” of adhesive parcels was spaced at a distance of 6.4 cm, along the pleat direction, from its neighboring columns of parcels. By way of a specific example again with reference to FIG. 8, the item marked 50_{b-c} would be 6.4 cm from the item marked 40_{a-b}, along the pleat direction, and would be 6.4 cm from the item marked 50_{a, b}, in the opposite direction along the pleat direction. In other samples, other spacings were used as discussed later herein.

### Diamond-Pleated Media

The above-described operations produced Working Example samples of diamond-pleated media. The front side of the media exhibited an appearance similar to the front-side photo of a Working Example diamond-pleated media of FIG. 10; the rear side of the media exhibited an appearance similar to the rear-side photo of a Working Example diamond-pleated media of FIG. 11. The diamond-pleated media could be reversibly expanded and contracted along the expansion direction as described earlier herein. Many of the samples of the diamond-pleated media were sized to have a breadth along the pleat direction of approximately 48 cm and to have an expanded, in-use length (“span”, using the terminology previously introduced) along the expansion direction of approximately 48 cm. (For these manually-produced samples, the linearly-pleated precursor media was usually pre-cut to the desired dimensions rather than being cut after transformation of the precursor media into a diamond-pleated configuration.) As discussed below, this particular expanded, in-use span of 48 cm was not necessarily the ultimate, maximum possible span of the media at which the junctions did not permit any further expansion. Rather, the diamond-pleated media was configured so that an expansion to this length/span provided the above-noted pleat height of approximately 1.57 cm and a pleat spacing of approximately 0.73 cm.

The diamond-pleated media samples thus exhibited a breadth along the pleat direction of approximately 48 cm and could be expanded along the expansion direction to a span of approximately 48 cm; at this expansion, the media exhibited a pleat height of approximately 1.57 cm. These samples could thus be expanded into a nominal filter size of 20″×20″×1″ (noting that a filter “size” of 20″×20″×1″ as commonly used e.g. for residential HVAC filters is a nominal value that includes the frame; the filter media of such filters typically has an actual pleat height of approximately 1.57 cm and actual media dimensions of approximately 48 cm×48 cm).

Most such diamond-pleated filter media samples easily achieved an expansion ratio in the range of 4:1 or greater (depending e.g. on the particular values of junction spacing, pleat spacing, and so on, that were used) and thus could be compacted to have a length/span along the expansion direction of as low as e.g. 13 cm, and could be expanded from this compacted configuration to an expanded configuration with a span of 48 cm or more.

### Representative Example

As noted above, Representative Example diamond-pleated samples were produced in which the junction spacing along each pleat was approximately 12.7 cm (5.0 inches), with the junctions provided by successive rows of adhesive parcels staggered at approximately 6.4 cm (2.5 inches) spacing in the general manner depicted in FIG. 8. These samples, as cut to desired lengths and widths, and with a pleat distance of approximately 1.63 cm as noted above, were expanded to an expansion ratio that provided a nominal 20″×20″×1″ air filter after framing. The filter media, as expanded in this manner, exhibited generally diamond-shaped, frontwardly-open-ended pockets of the general type described herein, with a pocket length (along the pleat direction) of approximately 12.7 cm (5.0 inches) and a pocket width (along the expansion direction) of approximately 0.73 cm. This pocket width was the maximum width of the pockets at their location of greatest extent in the pleat direction; each pocket tapered to a near-zero minimum width at the pleat-direction terminal ends of the pocket. Most such samples were installed into frames for testing, as discussed below.

### COMPARATIVE EXAMPLES

Comparative Examples were made using the same filter media, but without the media being diamond-pleated. Rather, in one case (Comparative Example CE-1) a supporting metal mesh was applied to both sides of the media to stabilize the media in its expanded, in-use configuration. The metal mash was in a flat condition and was bonded to the pleat tips only; the bonding of the metal mesh to the pleat tips of the filter media was performed using a roll-coated hot melt adhesive. The resulting samples of pleated media, with the pleat spacings having been “locked in” by the metal mesh applied to the pleat tips, were not significantly expandable/collapsible. The overall pleat spacing, pleat height, e.g., were comparable to those of the above-described Representative Working Example samples.

In another case (Comparative Example CE-2), a set of supporting members (in the form of flexible ribbons of approximately 1.3 cm width, with three such ribbons extending the length of the media along the expansion direction, and spaced across the pleat direction of the media, at approximately 10 cm spacing) were bonded to the pleat tips of one side of the pleated filter media by way of hot melt adhesive that was applied to the ribbons. This pleated, beribboned filter media was of a general type that resembled the filter depicted in FIG. 3 of U.S. Pat. No. 9,682,339, and was expandable/collapsible along the expansion direction. For testing, these Comparative Example samples were arranged to have overall pleat spacing, pleat height, and so on, that was comparable to those of the Representative Working Example samples.

### Testing

Samples of the Working Example diamond-pleated filters, along with samples of the Comparative Example conventionally-pleated filters, were evaluated for the above-described filtration performance parameters. (All samples were held at similar pleat spacings and so on, so that the performance could be directly compared.) For testing, samples were installed into reusable frames (usually at the above-noted nominal 20″×20″×1″ size). The frames were two-piece reusable frames of the general type depicted in FIG. 12, comprising lattices on the rear (downstream) side and on the front (upstream) side.

The Working Example samples exhibited, in all respects tested, filtration performance that was very similar to that of the Comparative Examples, thus indicating that the forming of junctions as described herein did not significantly reduce the area available for filtration, or otherwise affect the filtration performance.

In further detail, the diamond-pleated Working Example samples exhibited an average initial pressure drop of 0.23 inches of water, as compared to 0.21 inches of water exhibited by the CE-1 and the CE-2 samples. The diamond-pleated Working Example samples exhibited Composite Minimum E1, E2 and E3 values of 57.1, 86.9, and 95.4, versus 54.6, 84.7, and 93.3 for the CE-1 samples and 50.4, 87.8, and 94.6 for the CE-2 samples. The diamond-pleated Working Example samples achieved an overall MERV of 13, versus a MERV of 12 for the CE-1 samples and MERV of 13 for the CE-2 samples. The diamond-pleated Working Example samples achieved a Dust Holding Capacity of approximately 21 (grams per square meter), versus approximately 20 for the CE-1 samples and 21 for the CE-2 samples.

Thus again, in all measured aspects, the diamond-pleated filter media Representative Example samples performed extremely similarly to Comparative Example samples and confirmed that the advantageous effects allowed by the diamond-pleated arrangement could be achieved without sacrificing any filtration performance.

### Variations

As noted, the diamond-pleated Working Example samples could be expanded and contracted above and below the particular pleat spacing/pocket width (0.73 cm) used in the above Representative Example samples. The (maximum) pocket width, and the resulting aspect ratio of pocket length to pocket width, thus could be varied depending on the degree to which the media was expanded along the expansion direction. Working Example samples with the same pleat distance (1.63 cm) used above were expanded or contracted, accordion-style, from this 0.73 pleat spacing, to provide greater or smaller pleat spacings so that the effect of pleat spacing could be ascertained. The pleat spacings that were used were approximately 0.85, 0.64, 0.57, 0.51, 0.42, and 0.36 cm (corresponding to pleat frequencies of 3, 4.5, 5, 6 and 7 pleats per inch). Various of the above-discussed filtration performance parameters were evaluated in order that any effect of the pleat spacing could be ascertained. In terms of pressure drop, the resulting graph was slightly U-shaped, with the lowest pressure drop toward the center of the pleat-spacing range (e.g., at a pleat spacing of from approximately 0.51 to 0.57 cm). However, the change in pressure drop was not large (for the most part, all values were within a range of 20%) and the results for the Working Example samples were clustered near the above-listed values for the Comparative Examples.

The effect of the spacings of the junctions along the pleat direction on pressure drop was also evaluated. The Representative Example samples had junction spacings of 12.7 cm (5.0 inches) along each pleat as described above; additional samples were made and evaluated with spacings above and below this value. Working Example samples were made with junction spacings of approximately 7.6, 8.9, 10.2, and 15.2 cm (3.0, 3.5, 4.0, and 6.0 inches). (The photographs in FIGS. 10 and 11 are believed to be of a Working Example sample with a 7.6 cm (3.0 inch) junction spacing). In general, wider junction spacings led to lower pressure drops, and tighter spacings led to higher pressure drops. Again, however, all pressure drops were in a range deemed quite acceptable for actual use.

The effect of pleat spacing and junction spacing on Capture Efficiency was also evaluated. In this instance, E1, E2 and E3 values were obtained as Initial Efficiency values rather than as Composite Minimum E1, E2, and E3 values; nevertheless, they allowed the effect of pleat spacing and junction spacing to be characterized. In general, the E1, E2 and E3 values increased somewhat with a decrease in pleat spacing; the effect was greatest for E1, less for E2, and very low for E3. However, even for E1, the effect was rather insubstantial and all E1 values were in very acceptable ranges. With regard to junction spacing, the effect of this parameter was quite low across the entire range of pleat spacing (including for the E1 values) and again all values were in very acceptable ranges. Thus in summary, these data indicated that across the various geometric arrangements studied, the diamond-pleated filter media achieved excellent results in Capture Efficiency.

The above results were mainly obtained with Working Example samples of diamond-pleated media tested with the “front” side of the media facing upstream. (That is, the “open” end of the pockets, as pictured in FIG. 10, faced the incoming air.) However, some samples of diamond-pleated media were tested with the media reversed so that the “rear” side of the media (as pictured in FIG. 11) faced upstream. The filtration performance was in all respects very similar to that achieved with the diamond-pleated media in a front-upstream configuration (and to those achieved by the Comparative Example samples), indicating that it is possible to use the diamond-pleated filter media in this mode if desired.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate. It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein but to which no priority is claimed, this specification as written will control.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). To the extent that there is any conflict or discrepancy between this specification as written and the disclosure in any document incorporated by reference herein, this specification as written will control.

What is claimed is:

1. A diamond-pleated filter media comprising a front side with front pleat walls that define front pleats that exhibit front pleat tips and front pleat valleys; and, an opposing, rear side with rear pleat walls that define rear pleats that exhibit rear pleat tips and rear pleat valleys;
wherein at least some of the front pleats each comprise junctions at which local areas of adjoining front pleat walls of the front pleat are frontally joined together, the junctions being at discrete locations that are spaced along a pleat direction of the front pleats;
and,
wherein for at least some pairs of nearest-neighbor front pleats, the junctions of one of the front pleats are offset, along the pleat direction, from the junctions of the other front pleat.

2. The diamond-pleated filter media of claim 1 wherein the diamond-pleated filter media is in a compacted configuration in which for each front pleat, the adjoining front walls of the front pleat are in close abutment with each other along their entire length along the pleat direction, so that the front pleat valleys are substantially collapsed; and, in which for each rear pleat, adjoining rear walls of the rear pleat are in close abutment with each other along their entire length along the pleat direction, so that the rear pleat valleys are substantially collapsed.

3. The diamond-pleated filter media of claim 2 wherein the diamond-pleated filter media is expandable along an expansion direction that is at least generally orthogonal to the pleat direction into an expanded configuration in which:
the adjoining front walls of each front pleat are spaced apart from each other in the expansion direction, excepting at the junctions of the front pleats, at which junctions the local areas of the adjoining front pleat walls of the front pleat remain frontally joined together and in close abutment with each other.

4. The diamond-pleated filter media of claim 3 wherein the diamond-pleated filter media exhibits an expansion ratio of at least 3:1.

5. The diamond-pleated filter media of claim 3 wherein when the diamond-pleated filter media is in the expanded configuration and is viewed from the front side, each front pleat tip comprises a series of end-to-end connected line segments that collectively form a regular skew apeirogon with vertices that coincide with the junctions and that exhibit a vertex angle of from 150 to 175 degrees.

6. The diamond-pleated filter media of claim 3 wherein when the diamond-pleated filter media is in the expanded configuration and is viewed from the front side, the diamond-pleated filter media exhibits a plurality of frontally-open-ended, rearwardly-closed-ended pockets, each in the general shape of a rhombus that comprises a length that is aligned with the pleat direction and a width that is aligned with the expansion direction, and that exhibits a length to width aspect ratio of from 4:1 to 20:1.

7. The diamond-pleated filter media of claim 1 wherein the rear side of the diamond-pleated filter media does not comprise any junctions at which local areas of adjoining rear pleat walls of any rear pleat are rearwardly joined together, so that for each rear pleat, the adjoining rear pleat walls move apart from each other along an entire length of the rear pleat, when the diamond-pleated filter media is expanded from a compacted configuration to an expanded configuration.

8. The diamond-pleated filter media of claim 1 wherein each local area of a front pleat wall that is frontally joined to a complementary local area of an adjoining front pleat wall to form a junction, includes a region that is closer to the front pleat tip than to the front pleat valley floor, with the proviso that the local area does not include the front pleat tip.

9. The diamond-pleated filter media of claim 1 wherein each local area of a front pleat wall that is frontally joined to a complementary local area of an adjoining front pleat wall to form a junction, occupies from 10 to 90% of a pleat distance of the front pleat wall and includes a zone that is no further away from the front pleat tip than 20% of the pleat distance of the front pleat wall, with the proviso that the local area does not include the front pleat tip.

10. The diamond-pleated filter media of claim 1 wherein the local areas that are frontally joined together are joined together by hardened adhesive, the adhesive being present at a thickness that is less than 25% of a maximum pleat spacing of the front pleats of the diamond-pleated filter media when the diamond-pleated filter media is in an expanded configuration.

11. The diamond-pleated filter media of claim 1 wherein when the diamond-pleated filter media is in an expanded configuration, the diamond-pleated filter media exhibits a pleat height of from 1.5 cm to 2.5 cm and a pleat density of from 0.3 to 3 pleats per cm, and wherein the junctions are spaced along each pleat along the pleat direction, at a spacing of from 3.0 cm to 7.0 cm.

12. The diamond-pleated filter media of claim 11 wherein the diamond-pleated filter media comprises a thickness of less than 1.0 mm, wherein the pleat tips of the diamond-pleated filter media exhibit an average radius of curvature of less than 1.0 mm, and wherein the diamond-pleated filter media exhibits a Gurley stiffness of at least 150 mg.

13. The diamond-pleated filter media of claim 1 with the proviso that the diamond-pleated filter media does not comprise any pleat-stabilizing member or members bonded to the front-side pleat tips nor any pleat-stabilizing member or members bonded to the rear-side pleat tips.

14. The diamond-pleated filter media of claim 1 wherein for all of the pairs of nearest-neighbor front pleats, the junctions of one of the front pleats are offset, along the pleat direction, from the junctions of the other front pleat.

15. A method of making diamond-pleated filter media, the method comprising:
forming rows of oppositely-facing pleats in a filter media so that the ai filter media is a linearly-pleated filter media,
then,
frontally joining local areas of adjoining front pleat walls of front pleats of the linearly-pleated filter media to each other to form junctions at discrete locations that are spaced along a pleat direction of the front pleats, the junctions being arranged so that for at least some pairs of nearest-neighbor front pleats, the junctions of one of the front pleats are offset, along the pleat direction, from the junctions of the other front pleat.

16. The method of claim 15 wherein each junction at which local areas of adjoining front pleat walls of a front pleat are frontally joined together, is formed by depositing adhesive onto at least one of the local areas of the adjoining front pleat walls while the linearly-pleated filter media is not in a compacted configuration, after which the linearly-pleated filter media is compacted into a compacted configuration so that the local areas of the adjoining front pleat walls are brought together into close abutment, after which the adhesive is hardened to join the local areas together.

17. The method of claim 16 wherein the compacting of the linearly-pleated filter media into a compacted configuration so that the local areas of the front pleats are brought together into close abutment, causes the adhesive to be thinned from an as-deposited condition into a thickness that is less than 25% of a maximum pleat spacing of the front pleats of the diamond-pleated filter media when the diamond-pleated filter media is in an expanded configuration, with the adhesive then being hardened in this thinned condition.

18. A method of forming a filter assembly from the diamond-pleated filter media of claim 1, the method comprising:
expanding the diamond-pleated filter media along an expansion direction that is at least generally orthogonal to the pleat direction, so that the diamond-pleated filter media is expanded from a compacted configuration to an expanded configuration,
and,
installing the diamond-pleated filter media into a support frame.

19. The method of claim 18 wherein the diamond-pleated filter media is expandable into several possible expanded configurations of different spans in the expansion direction, and wherein the method includes expanding the diamond-pleated filter media to a span chosen to fit the particular support frame into which the diamond-pleated filter media is to be installed.

20. A method of filtering air, the method comprising: installing a filter assembly formed by the method of claim 18 into an air-handling apparatus or system with the front side of the diamond-pleated filter media facing upstream and operating the air-handling apparatus or system so that moving air is passed through the diamond-pleated filter media of the filter assembly and filtered thereby.
